(19) United States
(12) Patent Application Publication
(10) Pub. No.: US 2026/0220445 A1
(43) Pub. Date: Jul. 30, 2026

(54) SYSTEMS AND METHODS FOR INTERFACING LIVING BIOLOGICAL NEURAL NETWORKS

(71) Applicant: FLORIDA ATLANTIC UNIVERSITY BOARD OF TRUSTEES, Boca Raton, FL (US)

(72) Inventors: Erik ENGEBERG, Boca Raton, FL (US); Craig ADES, Boca Raton, FL (US); Moaed ABD, Boca Raton, FL (US)

(21) Appl. No.: 19/145,367

(22) PCT Filed: Jan. 3, 2024
(86) PCT No.: PCT/US2024/010171

§ 371 Date: Jul. 2, 2025

Related U.S. Application Data
(60) Provisional application No. 63/478,282, filed on Jan. 3, 2023.

(51) Int. Cl. G06N 3/06

(52) U.S. Cl. CPC G06N 3/061

(57) ABSTRACT

Disclosed herein are systems and methods for closed-loop drug and/or environmental evaluation. In various aspects, described herein is a neuro-interface platform comprising: a neurophysiological unit comprising a multielectrode array (MEA) disposed in a chamber with biological or synthetic tissue comprising neurons. A first electrode is configured to detect an efferent signal from the neurons at a recording region corresponding to neuronal activity, and a second electrode is configured to provide electrical stimulation to the neurons at a stimulation region. The platform further includes a sensorimotor unit comprising a test device, the test device being configured to be selectively controlled based on a measurement of the efferent signal and to concurrently sense an afferent signal from a sensor coupled to the test device. The platform also includes an interface unit configured to electrically couple the neurophysiological unit and the sensorimotor unit.

### RELATED APPLICATION

This application claims priority to, and the benefit of, U.S. Provisional Patent Application No. 63/478,282, filed Jan. 3, 2023, entitled “SYSTEMS AND METHODS FOR INTERFACING LIVING BIOLOGICAL NEURAL NETWORKS,” which is incorporated by reference herein in its entirety.

### STATEMENT REGARDING FEDERALLY SPONSORED RESEARCH OR DEVELOPMENT

This invention(s) was made with government support under contract number R01EB025819 awarded by the National Institutes of Health. The government has certain rights in the invention(s).

### BACKGROUND

The field of neuroprosthetics has tremendous potential to restore severed sensations of touch to amputees by use of electrodes implanted in peripheral nerves of the residual limb.

Research has explored the control and robotic embodiment of biological neural networks (BNNs) in closed-loop architectures with multielectrode arrays (MEAs) in vitro. Potter demonstrated the control of neural network bursting by modulating the stimulation voltage based on the culture-wide firing rate. Building upon this, the same group developed multiple closed-loop MEA architectures for action control. One developed a stimulation technique for goal-directed motion guidance of an animated display using living cortical neurons. Another demonstrated how the dynamics of BNNs impact the control of a robotic arm for an artistic painting display, and yet another controlled the motion of a simulated mobile robot. A recent work connected a BNN in MEA to the game “pong” using regions for input and output.

Another research reported integrated action and perception using a biological interface made from rats' cortical neurons cultured in MEA chambers. The bidirectional mobile robot control architecture mapped robotic sensory input to stimulate and alter neuronal dynamics and subsequently impact robotic behavior in an obstacle avoidance paradigm. Compartmentalizing the MEA chamber into different sections produced different system-level dynamics due to better separation between the input and output signals, producing simulated obstacle avoidance performances.

Another research examined improvements in neuroprosthetic hand control in a subject who, following amputation, was implanted with a transverse intrafascicular multichannel electrode interface to provide a proportional sense of the grip force via her ulnar nerve, conveying signals that SA mechanoreceptors had provided prior to amputation. The subject successfully demonstrated sensory-motor integration by improving grip force control of the artificial hand. Yet, the subject reported incongruent sensations of vibration (similar to what would naturally be transmitted by RA, not SA mechanoreceptors), revealing that hurdles still exist towards restoring haptic information with neurophenomenological fidelity.

With its inherent complexity, there remains much to learn in the field of touch sensation restoration. Nevertheless, regulatory, ethical, and financial constraints remain considerable challenges for state-of-the-art experimentation in vivo. For these reasons, only a limited number of patients have used bidirectional neuroprosthetic hands thus far, limiting research progress.

There is a benefit to improving interfaces to biological neural networks.

### SUMMARY

An exemplary neuroprostheses system comprising multielectrode arrays (MEAs) that is configured as a non-invasive Embodied Biological Computer (EBC) that can be used via Human-in-the-Loop (HIL) neuroprosthetic operation, e.g., to evaluate drugs and therapeutics or to be employed as a research platform for sensorimotor interactions. The Multielectrode Arrays (MEA) can provide a non-invasive device for evaluating invasive neuroprosthetic interfaces. The living Embodied Biological Computers (EBCs) may be employed for sensorimotor interactions, e.g., in NeuroProsthetic hands and other forms of RoboSynaptic embodiments.

The EBC system is configured to operate with reflex and perceptive abilities for human-in-the-loop operations that can be coupled to a robotic system, e.g., dexterous robotic hand that can provide (1) tactile interaction to evoke a response from the EBC due to a variety of stimulation encoding methods representing mechanoreceptor firing patterns naturally present in an intact hand, and (2) evoked responses to be relayed to the HIL. The system can operate with different encoding methods and can compare baseline EBC activity to embodied activity to detect statistical significance in spatiotemporal correlation.

In some embodiments, the system is configured as an invasive neuroprosthetic research platform that enables bidirectional electrical communications (action, sensory perception) between a dexterous artificial hand and neuronal cultures living in a multichannel microelectrode array (MEA) chamber. Artificial tactile sensations from robotic fingertips may be encoded to mimic slowly adapting (SA) or rapidly adapting (RA) mechanoreceptors. Afferent spike trains may be used to stimulate neurons in a region of the neuronal culture. Electrical activity from neurons at another region in the MEA chamber may be used as the motor control signal for the artificial hand. Artificial neural networks (ANNs) can be used to classify between tactile encoding methods. Results from ANNs showed that the haptic model used to encode RA or SA fingertip sensations affected biological neural network (BNN) activity patterns, which in turn impacted the behavior of the artificial hand. That is, the exhibited finger-tapping behavior of this closed-loop neurorobotic system showed statistical significance (p<0.01) between the haptic encoding methods across two different neuronal cultures and over multiple days.

In one aspect, disclosed herein is a neuro-interface platform comprising: a neurophysiological unit comprising a multielectrode array (MEA) disposed in a chamber with biological or synthetic tissue comprising neurons. The term “biological tissue” refers to a collection of similar cells combined to perform a specific function, and can include any extracellular matrix surrounding the cells. The term “synthetic tissue” refers to non-biological structures configured to emulate the function of biological tissue. A first electrode is configured to detect an efferent signal from the neurons at a recording region corresponding to neuronal activity, and a second electrode is configured to provide electrical stimulation to the neurons at a stimulation region. The platform further includes a sensorimotor unit comprising a test device, the test device being configured to be selectively controlled based on a measurement of the efferent signal and to concurrently sense an afferent signal from a sensor coupled to the test device. The platform also includes an interface unit configured to electrically couple the neurophysiological unit and the sensorimotor unit.

In some aspects, the interface unit is configured to receive the afferent signal from the sensor of the test device and to transmit an electrical action potential to the neurons at the stimulation region according to a neurocomputational model (e.g., Izhikevich model).

In some aspects, the platform further includes a processor; and a memory having instructions stored thereon.

In some aspects, the processor is configured to execute a trained AI model to classify the efferent signal and/or the afferent signal.

In some aspects, the processor is configured to evaluate a difference or change in the measurement of the efferent signal or the measurement of the afferent signal to a baseline measurement after a physical stimulus (e.g., light, pressure, sound, and/or heat) has been added to the chamber, (e.g., wherein the evaluation provides an assessment of the physical stimulus effects on the neurons).

In some aspects, the processor is configured to evaluate a difference or change in the measurement of the efferent signal or the measurement of the afferent signal to a baseline measurement after a pharmacologic agent or chemical has been added to the chamber (e.g., wherein the evaluation provides an assessment of the pharmacologic agent or chemical effects on the neurons).

In some aspects, the sensor comprises a tactile sensor. In some aspects, the sensor comprises an audio sensor (e.g., a microphone). In some aspects, the sensor comprises a visual sensor (e.g., a camera). In some aspects, the sensor comprises a thermal sensor. In some aspects, the sensor comprises a plurality of sensors. In some aspects, the sensor comprises a single sensor.

In some aspects, the test device comprises a robotic system. In some aspects, the test device comprises a prosthetic device. In some embodiments, the test dev ice is part of a virtual reality system. In some aspects, the sensorimotor unit comprises a plurality of test devices. In some aspects, the sensorimotor unit comprises a single test device.

In some aspects, the first electrode comprises a plurality of electrodes.

In some aspects, the second electrode comprises a plurality of electrodes.

In some aspects, the neurophysiological unit comprises a plurality of MEAs.

In some aspects, the neurophysiological unit comprises an array of chambers arranged to provide high-throughput evaluation.

In another aspect, a method is disclosed for drug evaluation via closed-loop testing of a biological response of a neuro-interface platform, the method comprising providing a neuro-interface platform comprising a multielectrode array (MEA) (e.g., a plurality of MEAs) disposed in a chamber with biological or synthetic tissue comprising neurons, and wherein the multielectrode array includes at least a first electrode and a second electrode; detecting, using the first electrode disposed at a recording region of the neuro-interface platform, an efferent signal from the neurons at the recording region, wherein the efferent signal corresponds to neuronal activity; selectively controlling a test device (e.g., robotic system) based on a measurement (e.g., of measured characteristic) of the efferent signal while concurrently sensing an afferent signal from a sensor coupled to the test device; and transmitting said afferent signal to the second electrode disposed at a stimulation region of the neurons, wherein the second electrode is configured to provide electrical stimulation to the neurons at the stimulation region.

In some embodiments, the method further includes generating, by a processor, a time-frequency coherence image from a time-frequency coherence analysis of the measurement of the efferent signal. In some embodiments, a spatiotemporal frequency decompositions, e.g., using wavelet transforms for individual electrode sites, can be performed and evaluated to produce coherence images to compare spatiotemporal information across multiple sites/regions/electrodes.

In some embodiments, the method further includes introducing a pharmacologic agent or chemical to the multi-electrode array chamber with the cultured tissue; and evaluating differences or changes in the measurement of the efferent signal or the measurement of the afferent signal to a baseline measurement (e.g., wherein the evaluation provides an assessment of the pharmacologic agent or chemical effects to the biological neural network.

The term “Biological Neural Network (BNN)” is used to describe the structural and functional connections within the MEA. After demonstrating the repeatable functional specializations of different encoding methods and their statistically significant behavioral outputs, the “Biological Neural Network (BNN)” described previously is referred to an “Embodied Biological Computer (EBC).”

The term “pharmacologic agent” and the like refers to any synthetic or naturally occurring biologically active compound or composition of matter which, when administered to an organism (human or nonhuman animal), induces a desired pharmacologic, immunogenic, and/or physiologic effect by local and/or systemic action. The term encompasses those compounds or chemicals traditionally regarded as drugs, vaccines, and biopharmaceuticals, including molecules such as proteins, peptides, hormones, nucleic acids, gene constructs, and the like. The agent may be a biologically active agent used in medical, including veterinary science, applications in agriculture, such as with plants, as well as other areas. The term pharmacologic agent also includes, without limitation, medicaments; vitamins; mineral supplements; substances used for the treatment, prevention, diagnosis, cure, or mitigation of disease or illness; or substances that affect the structure or function of the body; or pro-drugs, which become biologically active or more active after they have been placed in a predetermined physiological environment. Pharmacologic agents include, but are not limited to, anticancer therapeutics, antipsychotics, anti-inflammatory agents, and antibiotics.

Some specific examples of pharmacologic agents include, but are not limited to, beta-lactams, sulfonamides, quinolones, aminoglycosides, carboxyquinolones (e.g., ciprofloxacin, levofloxacin, moxifloxacin), protein synthesis inhibitors, vancomycin and related drugs (e.g., teicoplanin), ketolides, quinupristin and/or dalfopristin, linezolid, bacteriocins, mupirocin, anti-neoplastics, daptomycin, antiglycolytics, gluconeogenesis inhibitors, anti-metabolites (e.g., folate, pyrimidine, cytidine, purine), detergents (e.g., polymixin B, colistin), transitional metals, heavy metals, cycloserine, anti-fungals (e.g., amphotericin B, fluocytosine, imidazoles, triazoles, echinocandins), fermentation inhibitors, anti-herpes virus agents (e.g., acyclovir family), anti-influenza agents (e.g., amantadine family, oseltamvir, zanamivir), anti-hepatitis agents (e.g., adefovir, interferon-alfa, lamivudine, pegylated interferon), ribavirin, imiquimod, cidofovir, anti-retroviral agents, protease inhibitors, anti-malarials (e.g., quinine family, artemisinin family, atovaquone), eflornithine, melarsoprol, nitroimidazoles, pentamidine, sodium stibogluconate, other ancient antimicrobial agents to include heavy metal compounds, suramin, and benzimidazoles. Additional examples of pharmacologic agents include, but are not limited to, those found in Harrison's Principles of Internal Medicine, 13^{th} Edition, Eds. T. R. Harrison et al. McGraw-Hill N.Y., NY; Physicians' Desk Reference, 50^{th} Edition, 1997, Oradell N.J., Medical Economics Co.; Pharmacological Basis of Therapeutics, 8^{th} Edition, Goodman and Gilman, 1990; United States Pharmacopeia, The National Formulary, USP XIINF XVII, 1990; current edition of Goodman and Oilman's The Pharmacological Basis of Therapeutics; and current edition of The Merck Index, the complete contents of all of which are incorporated herein by reference.

As used herein, the term “chemical” broadly refers to elements and compounds that are introduced to the multi-electrode array chamber for purposes of evaluation. References to the term chemical is intended to include both inorganic and organic chemicals.

In some embodiments, the method further includes introducing a pharmacologic agent or chemical to the multi-electrode array chamber with the cultured tissue; and evaluating differences or changes in the measurement of the efferent signal or the measurement of the afferent signal to a baseline measurement (e.g., wherein the evaluation provides an assessment of the pharmacologic agent or chemical effects to the biological neural network).

In some embodiments, the biological neural network comprises a plurality of cultured mammalian neurons.

In some embodiments, the plurality of cultured mammalian neurons comprises cortical neurons.

In some embodiments, the recording region and stimulation region are located in a first section and a second section of the MEA chamber.

In some embodiments, the sensor comprises a tactile sensor.

In some embodiments, the test device comprises a prosthetic device.

In some embodiments, the first electrode assembly comprises a plurality of electrodes.

In some embodiments, the second electrode assembly comprises a plurality of electrodes.

In another aspect, a system is disclosed comprising a processor; and a memory having instructions stored thereon, wherein execution of the instructions by the processor causes the processor to perform any one of the above-discussed methods.

In another aspect, a non-transitory computer readable medium is disclosed having instructions stored thereon, wherein execution of the instructions by a processor causes the processor to perform any one of the above-discussed methods.

Indeed, the neuro-interface platform may be employed to evaluate the efficacy of pharmacologic agents and/or to assess the safety of chemical and environmental exposure.

### BRIEF DESCRIPTION OF THE DRAWINGS

The accompanying drawings, which are incorporated in and constitute a part of this specification, illustrate embodiments and, together with the description, serve to explain the principles of the methods and systems. The patent or application file contains at least one drawing executed in color.

FIGS. 1A and 1B shows an exemplary neuro-interface platform 100a for closed-loop drug and/or environmental evaluation.

FIG. 2 depicts a system-level diagram showing the hardware implementation of the CL noninvasive neuroprosthetic research platform. (panel a) is an extracellular recording region depicting MEA spiking activity, VMEA, that is transmitted to the Multichannel Systems Interface Board (MCS-IFB) (b) to detect neural events. For each event, a TTL pulse, MEAout, is transmitted from one of the digital output ports of (panel b) and relayed through one of the analog input ports of the National Instruments SCB-68A (panel c) to the efferent control switch (panel d) which can toggle between efferent substitution (ES) and closedloop (CL) signals to ROS Node 1 1. ROS Master (panel f) receives the motor control signals for controlling the desired joint angle, θD, and relays them to the internal controller of the Shadow Robot Hand (panel g). This manipulated two finger positions of the index finger for completing a tapping motion from not being in contact with the external environment, θ1 (panel g), to being in contact, θ2 (panel h). Upon contact, the BioTac tactile sensor (panel h) generates a force, FDC, and force rate of change, FAC, that are transmitted to ROS Node 2 (panel i) and converted into rapidly (RA) and slowly adapting (SA) mechanoreceptor firing patterns using the Izhikevich Neuron Model. SA and RA TTL pulse trains are transmitted to the Action Potential Generator (APG) board (panel j), which converts each pulse into a biomimetic action potential waveform. These waveform representations of RA and SA are sent into (panel c), which transmits a TTL signal, MEA in, through the afferent control switch (panel k), which can toggle on/off the afferent signals to the MCS-SCU (panel l) for triggering a preprogrammed waveform and apply an extracellular stimulation on the designated stimulation site (panel m) within the cultured neural network and evoke activity at the recording site (panel a). This closes the loop for the neuroprosthetic research platform.

FIG. 3 depicts results demonstrating the tapping experiments with RA and SA fingertip force encoding methods. (panel a) shows CL pipeline for obtaining ITI data. (panel b) and (panel f) are data from the afferent extracellular recording site where the decoded neural events (panels c, g) initiate a tapping motion of the artificial finger to contact the environment (panel j) and then return to no contact (panel k). This produced a tactile event that was encoded with an SA (panel d) or RA (panel h) method and relayed to the efferent extracellular stimulation site (panels e, i). ITT for the tapping events evoked by the neural activity in the MEA was calculated as the temporal difference between the initialization of each encoded tactile event.

FIG. 4 depicts a neurorobotic pipeline for extracting NeuroTactile events and embodiment sessions using continuous wavelet transforms and spatiotemporal wavelet coherences. This process begins at an efferent extracellular recording site (panel a). Detected events (panel b) elicit the tap of a finger and bring the joint angle from a no-contact state to a contact state (panel c). Upon contact, the tactile sensor values for static (panel d) and dynamic (panel e) force are encoded into tactile stimulation patterns (panel f). A continuous wavelet transform (panels g, j), is used to generate the amplitude-squared power, ASP (panels h, k). The mean of the ASP, mASPₜ (panels i, l), is calculated across time and smoothed using a moving mean with a window of 50 ms. A spatiotemporal wavelet coherence, Wcoh, is generated for each Neurotactile event (panel m) and each 5-minute embodiment session (panel o) using the smoothed afferent and efferent mASPₜ (panel n).

FIG. 5 depicts a neurorobotic pipeline for extracting NeuroTactile events and embodiment sessions using continuous wavelet transforms and spatiotemporal wavelet coherences. This process begins at an efferent extracellular recording site (panel a). Detected events (panel b) elicit the tap of a finger and bring the joint angle from a no-contact state to a contact state (panel c). Upon contact, the tactile sensor values for static (panel d) and dynamic (panel e) force are encoded into tactile stimulation patterns (panel f). A continuous wavelet transform (panels g, j) is used to generate the amplitude-squared power, ASP (panels h, k). The mean of the ASP, mASPₜ (panels i, l), is calculated across time and smoothed using a moving mean with a window of 50 ms. A spatiotemporal wavelet coherence, w_{coh}, is generated for each Neurotactile event (panel m) and each 5-minute embodiment session (panel o) using the smoothed afferent and efferent mASPₜ (FIG. 5, panel n).

FIG. 6 depicts an embodiment session of Injuries to The Peripheral Neural Pathways (Macro Scale View).

FIG. 7 depicts pseudo-code for processing the MEA Recordings into the continuous wavelet transform (CWT) and wavelet coherence (w_{coh}).

FIGS. 8A-8H depict an example of the pipeline for extracting NeuroTactile Events of RA and SA at the Efferent and Afferent electrode sites during an afferent deprived (AD), efferent substitution (ES), and CL (CL) events. FIG. 8A and FIG. 8D shows the efferent neural motor pool activations that elicited a tapping motion of the finger for rapidly and slowly adapting stimulation patterns. FIG. 8B and FIG. 8E shows the afferent electrode site where the encoded tactile interaction was stimulated. FIG. 8C and FIG. 8F shows the spatiotemporal wavelet coherence of the RA and SA events. FIGS. 8G-8H shows 12 random examples of input frames used to train the transfer learning algorithm for classifying SA and RA.

FIG. 9 depicts an Inter-Tap-Interval (ITI) comparison and statistical analysis for RA and SA tapping experiments from DIV21-23 for Afferent Deprivation (AD), Efferent Substitution (ES), and Closed-Loop Coupling (CL). Data showed functional specialization for ITI rates during the CL configuration. For DIV21-23, SA ITI rates were slower than RA rates showing a statistical significance of p<0.05.

FIG. 10 depicts a transfer learning classification validation accuracies for afferent deprivation (AD), efferent substitution (ES), and CL coupling sessions from DIV21-DIV23.

FIG. 11 depicts a non-invasive HIL neuroprosthetic research platform. (panel a) is an input sequence that controls the force, F_{D}, that the Shadow Hand (panel b) applied to the environment. Once in contact, the BioTac tactile sensor (panel b) produced the force components, F_{DC} and F_{AC}. The signals are mapped to RoboSynaptic Encodings (panel c) or a control scenario (panel d) for either stimulating the embodied biological computer (EBC) (panel e) or bypassing it, respectively. (panel f) shows neurohaptic decoding of the EBCs directly evoked activity including sampling the data, feature extraction, and mapping those features to the intensity of NeuroHaptic feedback. Depending on whether a control or stimulation trial, the haptic intensity modulates (panel g) the vibrotactile feedback of the InTact NeuroHaptic Module worn on the subject's arm. (panel h) shows EMG measurements record the subject's response to the onset and offset of the tactile sensation produced by the BioTac sensor.

FIG. 12 depicts a system configuration for managing data flow between the 3 subsystems. (FIG. 12, panel a) is the ROS master that controls the no contact (panel b) and contact (c) states. During contact, the Biotac tactile sensor produces static and dynamic forces F_{DC} and F_{AC}, respectively. These are relayed back to the ROS master to produce one of the robosynaptic stimulation encoding patterns. These are relayed to ROS node 1 (panel d) as MEAᵢₙ to send a trigger to the MCS-SCU (panel e) and stimulate the stimulation electrode (panel f) within the embodied biological computer (EBC) (panel g) Evoked activity at the recording electrode (panel h) is relayed through the MCS-IFB (i) to trigger a digital interrupt in ROS node 1. These interrupts are mapped to a duty cycle and relayed through the ROS master to ROS node 2 (panel j) for controlling the intensity of the InTact vibrotactile modules worn on the Human-in-the-Loop's (HIL) arm. (panel k) shows ROS node 3 recorded HIL responses to vibrotactile events through EMG sensors measuring the subject's muscle activity. This was relayed back to the ROS master.

FIG. 13A depicts a closed loop (CL) noninvasive neuroprosthetic platform. Within the cultured neuronal network in the MEA chamber (panel a) an extracellular recording site electrode is chosen for its healthy spontaneous firing behavior. Its multi-unit spiking activity is binned to compute the firing rate over time (panel b). The desired joint angle θ_{D} (panel c) was increased when firing rates above a set threshold were detected to initiate a finger-tapping motion of the Shadow Robot Hand (panel d). The haptic activity elicited by the tapping is captured by artificial tactile sensors, its signal decomposed into steady, FDC, and transient, FAC, components (panel e) and then converted into pulse trains using the Izhikevich Neuron Model (encoding Slowly Adapting signals in (f) and Rapidly Adapting in (panel g). Those biomimetic afferent pulse trains are electrically transferred to the extracellular stimulation site electrode of the MEA. As a result of this spontaneous coordination of recording and stimulation sites, a CL system is completed that provides a platform for investigating the impact of tactile sensor encoding methods on the CL sensorimotor behavior of the neurorobotic system.

FIG. 13B shows an example hardware implementation of the platform of FIG. 13A in accordance with an illustrative embodiment.

FIG. 14 depicts data flow of the signals cascading from robot behavior to EBC and HIL behavior. The sequencer (panel a) brings the BioTac into contact with the environment, increasing the forces F_{DC} and F_{AC} (panel b). These signals are encoded into their respective biomimetic pulse trains (panel c) depending on the current trial in the sequence (panel d). This figure demonstrates when the sequence is 1 and Izhikevich RA is used for RoboSynaptic encoding. These stimulations into the EBC produce evoked activity (panel d) for analyzing the EBC behavior. This activity is decoded into vibrotactile feedback administered to the HIL. EMG sensors on the forearm record the HIL EMG responses (panel e) for analyzing the HIL behavior. Threshold-based event detection is performed on each of the signals above for all experimental trials to analyze relative timing between the robot, EBC, and HIL behavior for the various methods of encoding.

FIGS. 15A-15F depict a data processing pipeline from robosynaptic encoding methods (FIGS. 15A-15D) to evoked EBC activity (FIG. 15F). FIGS. 15A-15D shows zoomed-in windows from the full sequence I, representing examples of the 4 robosynaptic encoding methods in red and their evoked EBC activity in black. FIG. 15F shows the relationship between each individual stimulation pulse timestamp (red, top) and the evoked activity timestamps (blue, bottom). Note that the responses to linear PFM (FIG. 15A) and SA (FIG. 15C) encoding patterns only produced evoked activity at the onsets, while RA (FIG. 15B) and biomimetic (FIG. 15D) encoding patterns produced evoked responses at both the onset and offset. The stimulation and evoked timestamps shown in FIG. 15F, were extracted to analyze the temporal relationship and compare across all datasets.

FIG. 16 depicts pseudo-code for processing the MEA Recordings into vibrotactile neurohaptic feedback to administer to the subjects.

FIGS. 17A-17C depict a cross-correlogram showing relative timing between stimulation and recording sites within the EBC for comparisons of baseline and evoked activity. This provides a quantitative measure of the temporal correlation between robosynaptic encoding timestamps and the EBC's evoked response timestamps. FIG. 17A shows the temporal relationship of baseline before the stimulation sessions. FIG. 17B shows the effects of the robosynaptic encoded stimulations on the evoked activity in the EBC. FIG. 17C shows the baseline activity after the stimulation sessions.

FIG. 18 depicts a cross-correlogram showing temporal correlation between robosynaptic encodings and HIL EMG responses. 6 subjects were distributed across 2 EBCs. Threshold-based event detection extracted timestamps for each robosynaptic stimulation encoding and HIL EMG response. Relative timing between the encoded events and the HIL's EMG responses show temporal correlations of approximately 250-500 ms reaction times across the subjects.

FIG. 19 depicts a two-sample Kolmogorov-Smirnov goodness-of-fit hypothesis test showing the temporal correlation between robosynaptic encoding methods and HIL EMG responses from the cross-correlation datasets shown in FIG. 18. This provides a statistical measure of whether the distribution of each dataset is from the same distribution or different distributions. Values of “1” represent a different distribution and a value of “0” represents the same distribution. This test is used to analyze the similarities and differences between different encoding methods and the HIL EMG responses they evoked through the EBC.

FIG. 20 depicts a flowchart showing a transfer learning pipeline using AlexNet including model hyperparameters.

### DETAILED DESCRIPTION

Each and every feature described herein, and each and every combination of two or more of such features, is included within the scope of the present invention, provided that the features included in such a combination are not mutually inconsistent.

### Example Systems

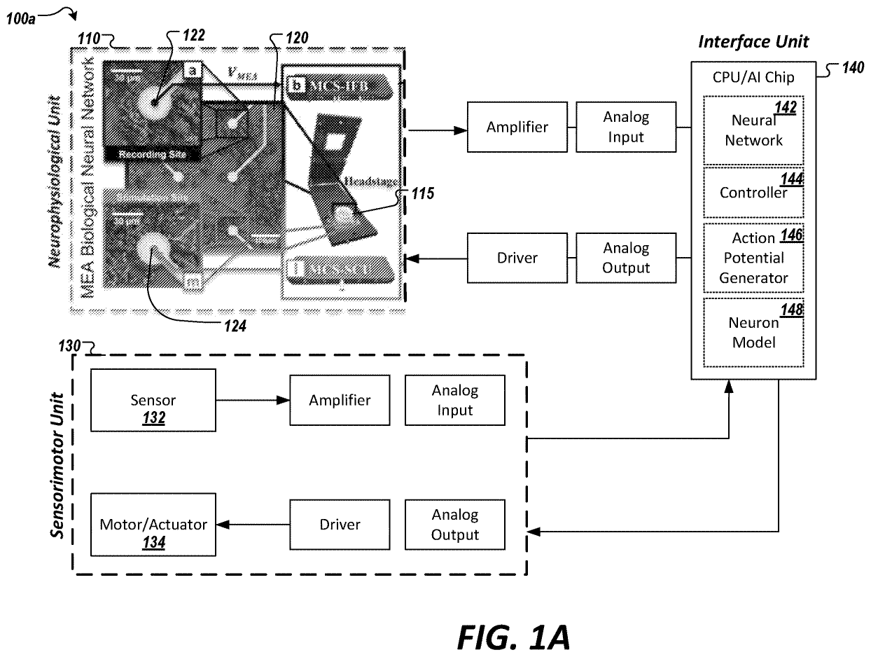

FIGS. 1A and 1B each shows an exemplary neuro-interface platform 100 (shown as 100a, 100b, respectively) for closed-loop drug and/or environmental evaluation or to develop neuro-technological interface algorithms and techniques.

In the example shown in FIG. 1A, the neuro-interface platform 100a includes a neurophysiological unit 110 having a multielectrode array (MEA) disposed in a chamber 115. Typically, MEAs are devices having a plurality of microelectrodes arranged on a substrate to record neural activity. The number of microelectrodes in each MEA can vary, for example, from two electrodes to thousands of electrodes. In the neurophysiological unit 110, the MEA includes a first electrode 122 at a recording region and a second electrode 124 at a stimulation region. The chamber 115 is configured to house biological or synthetic tissue comprising neurons 120 as well as other components.

In FIG. 1A, the first electrode 122 is configured to detect an efferent signal from the neurons at the recording region corresponding to neuronal activity. The second electrode 124 is configured to provide electrical stimulation to the neurons 120 at the stimulation region. When the first electrode 122 of the MEA acquires an electrical signal (e.g., spike trains) denoting neuronal activity of the neurons 120 at the recordation region, it is amplified to enhance the strength of the efferent signal. The efferent signal may be further processed using filters to facilitate data processing (e.g., to remove frequencies outside of 3.5 kHz and 100 Hz).

The neuro-interface platform 100a of FIG. TA further includes a sensorimotor unit 130 comprising a test device (shown as motor/actuator 134). The test device 134 is configured to be selectively controlled (e.g., between different operation states) based on a measurement (e.g., of measured characteristic) of the efferent signal and to concurrently sense an afferent signal from a sensor 132 coupled to the test device 134. The test device can be a robotic system. In other embodiments, the test system is a virtual reality platform to which the sensorimotor unit 130 can interface.

The neuro-interface platform 100a further includes an interface unit 140 that is configured to electrically couple the neurophysiological unit 110 and the sensorimotor unit 130. The interface unit 140 is configured to receive the afferent signal from the sensor 132 of the sensorimotor unit 130 and to transmit an electrical action potential (e.g., using the action potential generator 146) to the neurons at the stimulation region according to a neurocomputational model 148. The sensorimotor unit 130 includes front end circuits comprising amplifier and conversion circuitries and driver and analog output to interface to the sensor 132 and motor 134.

In FIG. 1A, the interface unit 140 includes instructions to execute a neural network module 142, a controller 144, the action potential generator 146, and a neuron model 148.

The neural network module 142 includes an artificial neural network configured to classify tactile encoding. The neural network 142 may receive time-frequency image coherence data as inputs for training and later inference operation.

The controller 144 is configured, via computer readable instructions, to execute an application. In some embodiments, the application can include a Human-In-The-Loop (HIL) operation to provide RA and SA encoding interface. In some embodiments, the operation can be used to monitor changes in RA or SA encoding during to an external stimuli applied to the biological neurons in the neuro-interface platform. In some embodiments, the application can include a Human-In-The-Loop (HIL) operation to provide sensory input and/or motor output to a user, e.g., in a prosthetic or cybernetic application.

The action potential generator 146 can provide the encoding of a desired motor output to a frequency modulated output corresponding to neural firing patterns, e.g., for the motor/actuator 134.

The neuron model 148 includes one or more neurocomputational models to interpret an sensory input of the BNN via the sensor 132.

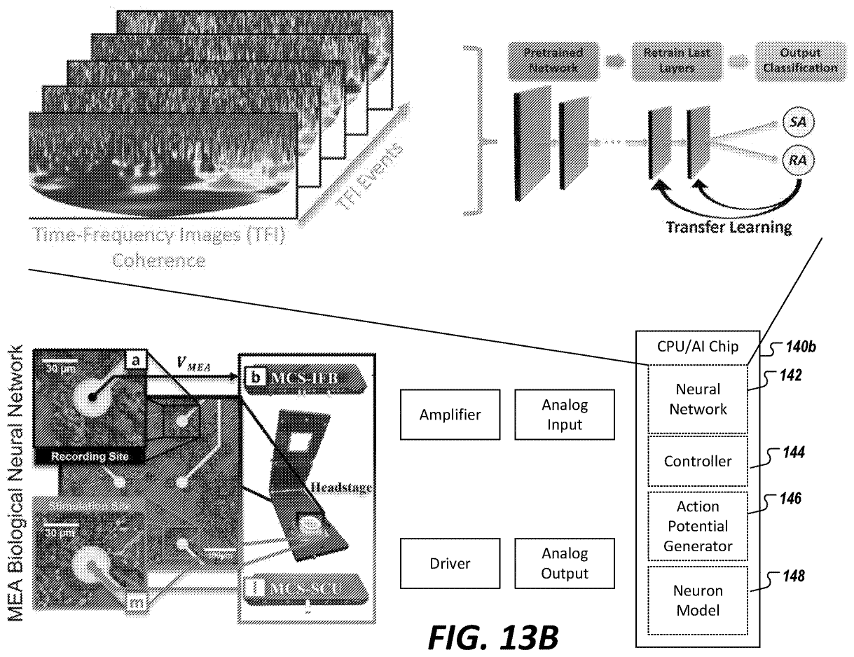

FIG. 1B shows another configuration of the neuro-interface platform 100 (shown as 100b). In the example shown in FIG. 13B, the system 100b includes multiples of the sensorimotor units 130 (shown as 130a, 130b, . . . 130c). The sensorimotor units 130a-130c may interface to a set of distributed computing devices (shown as “Distributed CPU/AI chip”) that interface to the interface unit 140 (shown as 140′).

Various neurocomputational models (e.g., employed in neural model 148) can be used to computationally reflect neural activity. Although the neuro-interface platform uses an Izhikevich model (e.g., in model 148) based in part on its computational efficiency, other representations can also be used (e.g., the Hodgkin-Huxley model or the integrate-and-fire model). The interface unit 140 further includes a processor (shown as controller 144) to control electrical activity and perform calculations.

In some aspects, the processor is configured to evaluate a difference or change in the measurement of the efferent signal or the measurement of the afferent signal to a baseline measurement after a pharmacologic agent or chemical has been added to the chamber, (e.g., wherein the evaluation provides an assessment of the pharmacologic agent or chemical effects on the neurons).

In some aspects, the processor is configured to evaluate a difference or change in the measurement of the efferent signal or the measurement of the afferent signal to a baseline system after a pharmacologic agent or chemical has been added to the chamber, (e.g., wherein the evaluation provides an assessment of the pharmacologic agent or chemical effects on the neurons).

### Example #2: Robosynaptic Embodiment: Closing the Loop on the Tactile Behavior of Artificial Sensation

Amputation of an upper limb is a devastating injury that impacts millions of people worldwide [112]. The severance of afferent neural pathways deprives amputees of the rich multimodal sensations of touch afforded by the broad distribution of mechanoreceptors in the human fingertips [113], adversely impacting motor control of prosthetic limbs [114]. The field of neuroprosthetics has tremendous potential to restore severed sensations of touch to amputees by use of electrodes implanted in peripheral nerves of the residual limb [23]. The robotic capability to sense haptic properties is well-established [115], and prosthetic fingertip sensations can be encoded into frequency-modulated spike trains to convey graded biomimetic sensations of touch to amputees outfitted with neuroprosthetic limbs [18]. Mechanoreceptors from the human glabrous skin fall into two broad categories: slowly adapting (SA) and rapidly adapting (RA). Each type of mechanoreceptor is responsible for processing and encoding a different aspect of tactile experience depending on specific spatiotemporal properties and response functions. Generally speaking, SA mechanoreceptors can detect static pressure, texture, and lateral skin stretch, while the RA mechanoreceptors are used to sense sliding contact and high-frequency vibration [113], among other sensations and modalities combining the two.

Several prior works fruitfully explored the control and robotic embodiment of biological neural networks (BNNs) in closed-loop architectures with MEAs in vitro. Potter and colleagues demonstrated control of neural network bursting by modulating the stimulation voltage based on the culture-wide firing rate [116]. Building upon this, the same group developed multiple closed-loop MEA architectures for action control. One developed a stimulation technique for goal-directed motion guidance of an animated display using living cortical neurons [42]. Another demonstrated how the dynamics of BNNs impact the control of a robotic arm for an artistic painting display [43], and yet another controlled the motion of a simulated mobile robot [117]. A recent work connected a BNN in MEA to the game “pong” using regions for input and output [118].

A breakthrough work integrated action and perception. It used a biological interface made from rats' cortical neurons cultured in. This bidirectional mobile robot control architecture mapped robotic sensory input to MEA chambers to stimulate and alter neuronal dynamics and subsequently impact robotic behavior in an obstacle avoidance paradigm [119]. Compartmentalizing the MEA chamber into different sections produced different system-level dynamics due to better separation between the input and output signals, producing simulated obstacle avoidance performances [120].

In a challenging paradigm in vivo, a study examined improvement in neuroprosthetic hand control in a subject who, following amputation, was implanted with a transverse intrafascicular multichannel electrode interface to provide a proportional sense of the grip force via her ulnar nerve, conveying signals that SA mechanoreceptors had provided prior to amputation [22]. The subject successfully demonstrated sensory-motor integration by improving grip force control of the artificial hand. Yet, the subject reported incongruent sensations of vibration (similar to what would naturally be transmitted by RA, not SA mechanoreceptors) [22], revealing that hurdles still exist towards restoring haptic information with neurophenomenological fidelity.

With this inherent complexity, there remains much to learn in the field of touch sensation restoration. Nevertheless, regulatory, ethical, and financial constraints remain considerable challenges for state-of-the-art experimentation in vivo. For these reasons, only a limited number of patients have used bidirectional neuroprosthetic hands thus far [121], limiting research progress.

To circumvent these bottlenecks, disclosed is a noninvasive neuroprosthetic research platform that enables bidirectional electrical communication between a dexterous artificial hand outfit with tactile sensors and a living BNN cultured in an MEA (FIG. 13A, panels a-g). To demonstrate this platform, RA or SA tactile sensations from the robotic fingertip (FIG. 13A, panels i-g) were used to biomimetically stimulate the neurons in the MEA and the recorded neuronal activity was decoded to control the robotic hand (FIG. 13A, panels b-d). This form of BNN embodiment removes many of the regulatory and financial barricades required for invasive human studies. This platform could catalyze a deeper understanding of the interaction between biological and artificial components of neuroprosthetic limbs with high throughput implementation to aid in restoring severed sensations of touch to amputees.

To demonstrate this neuroprosthetic platform, artificial neural networks (ANNs) were recently used to pattern-match inputs and outputs within bidirectional BNNs [122]. In this study, it was shown that ANNs can be used to classify differences in BNN activity due to different pulse train patterns, in this case, bioinspired SA or RA encodings of fingertip tactile sensations, that different neuronal activity patterns elicit different robotic behaviors in a closed-loop (CL) fashion, and the CL coupled behavior was compared to open loop (OL) scenarios of afferent deprivation (AD) and efferent substitution (ES), representing an amputation, congenital limb difference, or peripheral nerve damage.

One aim of this study was to explore the embodied behavior of a BNN when reciprocally coupled to an artificial hand's sensorimotor system. The study investigated efferent and afferent signaling using spatiotemporal analysis tools for evaluating coordination.

In neuroprosthetic systems, embodied behavior can be described as the coordination between receptive fields that are coupled across space and time depending on the type of embodiment a field is being exposed to, entangling the two regions.

The study developed a BNN embodied with different biomimetically accurate stimulation patterns (RA/SA in this case) to provide a coupling relationship from two relative perspectives: (1) the neural behavior of the culture to elicit a movement of the finger based on the response from the tactile sensor and (2) the robo-tactile behavior that stimulates the culture based on the motor commands from the culture. By programming the translation between domains (efferent motor control and afferent tactile pattern), this coupled relationship can be measured in a quantifiable way—in this case, exhibited behavior and spatiotemporal coherence (or coordination) over time. This study evaluated the coupled behavior for robotic embodiment sessions representing peripheral nerve open- and CL connectivity states, e.g., afferent deprivation (AD), efferent substitution (ES), and CL coupling for biomimetically modeled slowly (SA) and rapidly adapting (RA) mechanoreceptor firing patterns.

FIG. 13B shows an example hardware implementation of the platform of FIG. 13A in accordance with an illustrative embodiment. In FIG. 13B, the biological neural network includes front end circuits comprising amplifier and conversion circuitries and driver and analog output to interface to the sensor 132 and motor 134. The analysis system/controller 140 (shown as 140b)

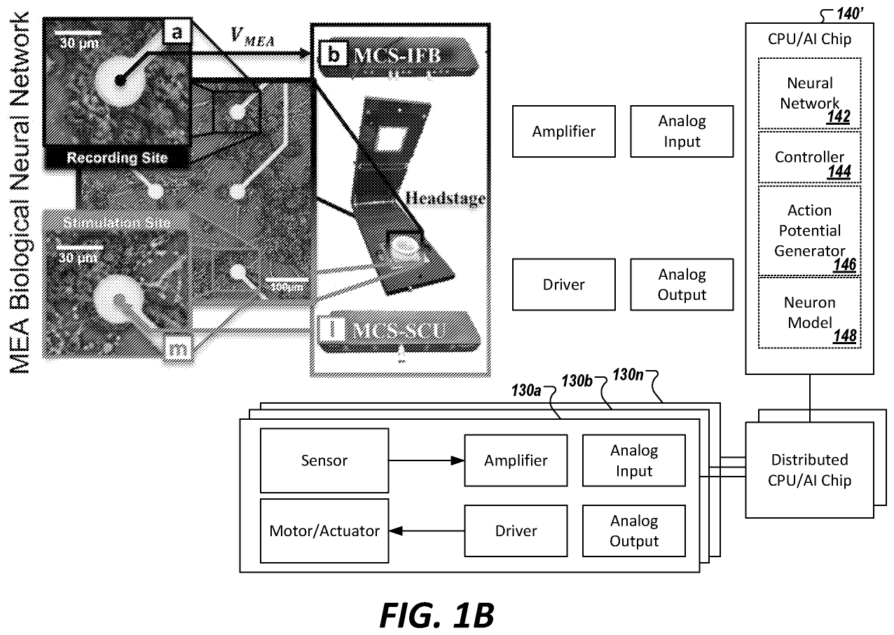

CL Neurorobotic system overview. The exemplary system may be implemented as a non-invasive CL neuroprosthetic platform developed for investigating sensorimotor interactions of an artificial hand and a tactile sensor electrically coupled to a BNN cultured in an MEA chamber [55]. Two switches were introduced (FIG. 2, panel d; FIG. 2, panel k) to control afferent and/or efferent signaling and enable the investigation of neural and robotic behavior at various stages of integrating artificial hands with sensorimotor capabilities.

This CL platform includes two subsystems. The first subsystem is the robotic unit (FIG. 2, panels a-m, right panel) which includes a Shadow Hand (Shadow Robot Company, London) fit with BioTac SP tactile sensor array (SynTouch, CA) and a PC using Robot Operating System (ROS, Open Robotics, CA) to manage efferent (FIG. 2, i, ROS Node 1) and afferent (FIG. 2, panel i, ROS Node 2) computations. Node 1 uses efferent signaling from the BNNs (FIG. 2, panels a-c) to compute the motor control signals for the artificial hand. Node 2 converts the BioTac pressure signals into afferent pulse trains of action potentials in real-time (FIG. 2, panels h-i). The pulse trains were passed to a custom-fabricated action potential generator (APG) board (FIG. 2, panel j) that triggered neurostimulations according to a neurocomputational model (e.g., 148) of haptic encoding.

The second subsystem is the neurophysiological unit (FIG. 2, panels a-m, left panel), which includes the head stage of the MEA (MultiChannel Systems, Reutlingen, Germany) that houses the BNN culture, signal collector unit, interface board, and their interconnection. The MEA has 200 μm inter-electrode distance and 30 μm diameter electrodes made from titanium nitride. The data acquisition of the MEA relies on a dedicated high-performance workstation optimized for storage capacity, fast data transfer, and temporal accuracy of the high-density, high-frequency signals (60 channels, 20 kHz) that were sampled from the neuronal culture. Online data were filtered with lowpass, and highpass Butterworth filters with cutoff frequencies set to 3.5 kHz and 100 Hz, respectively, to reliably eliminate unstable baselines in real-time and avoid artifacts. An additional data stream with the highpass filter set to 1 Hz was preserved for further offline classification with ANNs.

The study selected a pair of electrodes for their healthy spontaneous activity. One of the sites was assigned the function of recording electrode: it provided the efferent signals to operate the artificial hand. Its spike events (FIG. 2, panel a) were routed through ROS node 1 (FIG. 2, panel i) to elicit the robotic finger-tapping behavior. The other site (FIG. 2, panel m) was assigned to be the stimulation electrode, and it used the haptic feedback from the encoded robotic fingertip sensations. To ensure compatibility with spike signaling in the BNN, the tactile signals received from the BioTac sensor were transformed into afferent trains of action potentials (FIG. 13A, panels i-g FIG. 2, panels g-i) via the Izhikevich model [17].

The SCB-68A DAQ (National Instruments, TX) was placed at the interface between both subsystems (FIG. 2, panel i). Real-time feedback tests were performed to quantify the delay between instructed stimulation in Simulink (ROS Node 2), its detection by the MultiChannel System's proprietary software of the MEA and return of the signal back to Simulink. CL latency was consistently between 0.8-1.0 ms.

Efferent Decoding for motor control: An efferent NeuroRobotic control signal was implemented in ROS Node 1 (FIG. 2, panel i), with spike trains from the recording site of the MEA as input to specify the desired joint angle (θ_{D}) of the Shadow Hand's index finger metacarpophalangeal (MCP) joint. Briefly, the algorithm performed three functions: first, thresholding of its biological neural input signal to separate spikes from background noise. Second, a temporal aggregation to recruit MEA neural activity that satisfies criteria over a neurophysiologically-meaningful time interval. And third, a desired index finger MCP joint angle signal for triggering robotic fingertip tapping motions to generate fingertip forces.

For computational efficiency, the extracellular multiunit MEA activity, V_{MEA} (FIG. 2, a), from the selected recording electrode was used as an input to the efferent decoding algorithm for motion control of the Shadow Hand. Spikes (S) were detected per Equation 1.

$$S = \{ \begin{matrix}0 & if ( {V}_{MEA} < {V}_{thres} ) \\ 1 & if ( {V}_{MEA} \geq {V}_{thres} )\end{matrix} \qquad ( Eq . 1 )$$

In Equation1, Vₜₕᵣₑₛₕ is the action potential spike detection threshold. Subsequently, S was summed over a window of time, BinSize (50 ms, (FIG. 13A, panels b-c), and compared to a spatiotemporal aggregation coefficient, Sₜₕᵣₑₛ (3 spikes to provide a tapping rate within the operational bandwidth of the finger). Then, the algorithm outputs a TTL pulse of 100 ms, MEAₒᵤₜ, determined per Equation 2.

$${MEA}_{out} = \{ \begin{matrix}0 & if ( {\sum }_{i = 0}^{BinSize} S ) < {S}_{thres} \\ 1 & if ( {\sum }_{i = 0}^{BinSize} S ) \geq {S}_{thres}\end{matrix} \qquad ( Eq . 2 )$$

A switch, Switch_{Eff}, was introduced (FIG. 2, panel d) to toggle between different embodiment modes (CL, ES).

MEAₒᵤₜ affects the desired joint angle (θ_{D}) of the Shadow Hand finger per Equation 3.

$${θ}_{D} = \{ \begin{matrix}{θ}_{1} & if ( {MEA}_{out} = 0 ) \\ {θ}_{2} & if ( {MEA}_{out} = 1 )\end{matrix} \qquad ( Eq . 3 )$$

Desired joint angle θ₁ corresponds to a fully open hand, where the fingertip does not contact anything. However, desired joint angle θ₂ corresponds to index finger flexion to create fingertip contact with a surface, producing tactile forces. The measured joint angle, θ, was realized by a PID joint angle controller of the tendon-driven Shadow Hand. The joint angle (θ) is related to the fingertip force (F_{DC}) by Equation 4.

$$B ( θ ) \ddot{θ} + C ( θ , \dot{θ} ) \dot{θ} + {F}_{fr} \dot{θ} + g ( θ ) = {τ}_{a} {τ}_{fr} - {J}^{T} ( θ ) {F}_{D C} \qquad ( Eq . 4 )$$

In Equation 4, B(θ) is the inertia matrix, C(θ, θ) is the matrix representing the Coriolis and centrifugal forces, F_{fr} is the viscous friction coefficient, g(θ) is the vector representing the gravitational effect, rₐ is the actuating joint torque, r_{fr} is the joint friction, J is the Jacobian matrix of the finger kinematics, and F_{DC} is the contact force at the fingertip [123]. Both F_{DC} and the rate of change of the fingertip force (F_{AC}) are used within the Izhikevich neurocomputational model (e.g., 148) to generate SA and RA afferent action potential pulse trains that electrically stimulated the neuronal cultures (FIG. 13A, panels i-g).

Afferent Encoding of Tactile Sensations: The afferent NeuroRobotic feedback signals were implemented in ROS Node 2 (FIG. 2, panel i) for SA or RA encodings of tactile sensations as the feedback signals to the MEA (FIG. 2, panels h-m).

Izhikevich Model for SA and RA Mechanoreceptors: Upon robotic fingertip contact with the environment, the Izhikevich neurocomputational model [17] was employed to convert the tactile fingertip forces (F_{DC}, F_{AC}, (4)) into spike trains of action potentials representative of RA and SA mechanoreceptors [113](sample data shown in FIG. 13A, panels i-g). The neuron input current, Iᵢₙₚᵤₜ, was generated corresponding to the RA and SA experiments, respectively:

$${I}_{{input}_{S A}} = β + {k}_{S A} {F}_{D C} + {k}_{R A} {F}_{A C} \qquad ( 5 )$$

$${I}_{{input}_{R A}} = α + {k}_{R A} {F}_{A C} \qquad ( 6 )$$

Where, α, β, k_{SA}, k_{RA} are constants for tuning the tactile firing patterns. SA and RA pulse trains using input currents (5) and (6), respectively, were generated using the Izhikevich neuron model (e.g., 148) [17] per Equations 7-9.

$$\dot{v} = {Xv}^{2} + Yv + Z + \frac{{I}_{input}}{w} - u \qquad ( Eq . 7 )$$

$$if v \geq 30 mV , then \{ \begin{matrix}v ← c \\ u ← u + d \\ {MEA}_{i n} = 4.5 V\end{matrix} \qquad ( Eq . 8 )$$

$$else \{ \begin{matrix}v ← v \\ u ← u \\ {MEA}_{i n} = 0 V\end{matrix} \qquad ( Eq . 9 )$$

In Equations 7-9, ν is the membrane potential, u is the adaptation variable, and X, Y, Z, W are standard parameters for the model. Parameters a, b, c, and d are decay rates, sensitivity, membrane rest potential, and reset values, respectively (Table 1). MEAᵢₙ is the signal sent to trigger a stimulation of neurons cultured in the MEA system (FIG. 2, panels i-m). This model (e.g., 148) was implemented in real-time using Python 3.

TABLE 1
Izhikevich Model Parameters

| a | b | c | d | X | Y | Z | W |
|---|---|---|---|---|---|---|---|
| 0.1 | 0.2 | −0.65 | 8 | 0.04 | 5 | 140 | 1 |

Action Potential Generator Board: A custom-made APG board was developed to forward the action potential-like electrical stimuli representing the RA and SA spiking patterns to the MEA. The APG board has eight independently customizable stimulation channels, two of which were used in the present study. Stimulation pulses are output from the APG digitally using the onboard Teensy 3.6 microcontroller via two quad 16-bit digital-to-analog converters with a high-speed SPI interface. Its digital-to-analog output was low-pass filtered and fed to an output amplifier providing a user-selectable gain. A switch, Switch_{Aff}, was introduced (FIG. 2, k) to control the flow of this afferent signaling during open- and CL experiments. When Switch_{Aff} was closed, the afferent signal, MEAIn was transmitted to the MEA's stimulator control unit (MCS-SCU) to stimulate the afferent electrode site. When Switch_{Aff} was open, the afferent signal was not transmitted, and no stimulation occurred. The stimulation wave shape and amplitude used was a positive-first biphasic pulse (2 mV, 400 ms/phase).

### Experimental Results of Example #2

A study was conducted to develop a bidirectional noninvasive neuroprosthetic research platform that can be used to study the interaction between living BNNs and embodied robotic systems. Results showed that the encoding of tactile sensations from a robotic fingertip in an SA or RA action potential stimulation pattern impacted the behavior of the BNNs in the MEAs across multiple days. Correspondingly, the different patterns of coupled BNN activity impacted the behavior of the artificial hand in a CL fashion as evidenced by the statistically significant ITIs.

Culturing Biological Neural Networks in Multielectrode Arrays: Primary cortical neurons were harvested from postnatal day 0-1 mouse pups. All animal procedures were approved by the Institutional Animal Care and Use Committee and in compliance with the National Institutes of Health Guidelines for the Care and Use of Laboratory Animals. Pups were euthanized by quick decapitation, and brains were immediately removed and placed in ice-cold dissection medium (1 mM sodium pyruvate, 0.1% glucose, 10 mM HEPES, 1% penicillin/streptomycin in HEPES-buffered saline solution). Cortex were extracted under a dissecting microscope and pooled together. The tissue was digested with 0.25% trypsin in the dissection buffer for 15 min at 37° C. followed by further incubation with 0.04% Dnase I (Sigma-Aldrich) for 5 min at room temperature. The digested tissue was triturated with a fire-polished glass pipette 10 times and cells were pelleted by centrifugation. Cells were split and plated at ~5,000 cells/mm² in an MEA-60 chamber (Multichannel systems), (FIG. 13A, panel a). The culture used was BrainPhys™ neuronal culture medium (STEMCELL Technologies Inc., Vancouver, BC). Culture media in the chamber was half-changed every three days. Spontaneous structural and functional connectivity was allowed to mature before the bidirectional neurorobotic experiments.

MEA Experimental Recording Protocol: Each day of experiments began with verification that system noise was within acceptable bounds with a fixed resistance test chamber provided by Multichannel Systems. The test chamber was recorded for 1 minute outside the incubator and then placed inside the incubator; allowing 20 minutes for the temperature to stabilize. Confirmation data were subsequently recorded for 1 minute. After confirming the system noise level was stable and consistent, the MEA chamber containing the BNN was inserted into the headstage (FIG. 2, panels a-m) and allowed to settle for 5 minutes. The chamber was recorded for 5 min with no stimulation to obtain a baseline of spontaneous neural activity.

Datasets were collected over 3 days in vitro (DIV). There were 3 embodiment sessions per day (afferent deprivation (AD), efferent substitution (ES), and CL coupling), and 2 mechanoreceptor firing pattern encodings per embodiment session (SA and RA), totaling 18 datasets during the SA and RA embodiment sessions. Non-stimulated embodiment sessions were only recorded for their designated 5 minutes (no baselines recorded before or after). For each DIV, the order of the SA and RA administration was alternated to provide a non-biased stimulation protocol. DIV21 and DIV22 were in the order of AD, ES, CL, while DIV23 was reversed for CL, ES, and AD.

Noninvasive Neuroprosthetic Embodiment Sessions: In the CL coupling sessions, both the afferent and efferent switches (FIG. 2, panel d, FIG. 2, panel k) were in a closed-circuit state to provide a sensorimotor embodiment session. This allowed the decoded neural signals to be coupled to the stimulated tactile encodings (RA and SA in this case) through the dynamics of both the biological culture's paired receptive fields and the artificial hand's tactile sensations.

In the AD sessions, the afferent pathways were disconnected by toggling the afferent switch (FIG. 2, panel k) to an open circuit state (no stimulation of tactile sensory signals to the MEA culture). This provided a mismatch between the motor output and the sensory input, decoupling the interactions for analysis of the robotic behavior due to spontaneous BNN activity. It should be noted that this scenario resembles traditional control of a prosthetic hand by an upper limb absent person: the person can control the hand but has no haptic feedback from the hand.

In the efferent substitution (ES) session, the afferent switch (FIG. 2, panel k) was in a closed circuit state, and the efferent switch (FIG. 2, panel d) was toggled to ES, substituting the decoded motor commands from the MEA with a fixed stimulation pattern to control the movement of the finger. For this embodiment session, movement of the finger was enabled by programming the desired angle (θ_{D}) to be a 0.25 Hz square wave, which continuously produced 2 s of tactile contact with the environment and 2 s without contact. This provided a mismatch between the motor output and the sensory inputs, decoupling the interactions for analysis of the neural behavior due to OL stimulation patterns.

Preventing Crosstalk from Stimulation Electrode to Recording Electrode: To study synaptic plasticity of the sensorimotor network in the MEA culture, it was important to ensure that the stimulation (MEAᵢₙ, FIG. 2, panel m) did not propagate through the culture medium to the recording electrode (MEAₒᵤₜ, FIG. 2, panel a) and cause depolarization of the efferent neuronal population directly. Therefore, the activation threshold (Vₜₕᵣₑₛₕ) was chosen for V_{MEA} (1) to be higher than the observed crosstalk from the stimulation electrode. It was verified that no temporally coincident spiking activity exceeded the background noise level at the stimulation site's 8 neighboring electrodes, showing a minimum of full width, half amplitude drop. In this way, methods were enacted to ensure that electrical activity from V_{MEA} and MEAₒᵤₜ (FIG. 2, panels a-b) was due to the synaptic connections between the recording (FIG. 2, panel a) and stimulation (FIG. 2, panel m) electrodes in the MEA chamber, not due to direct stimulation from a distance.

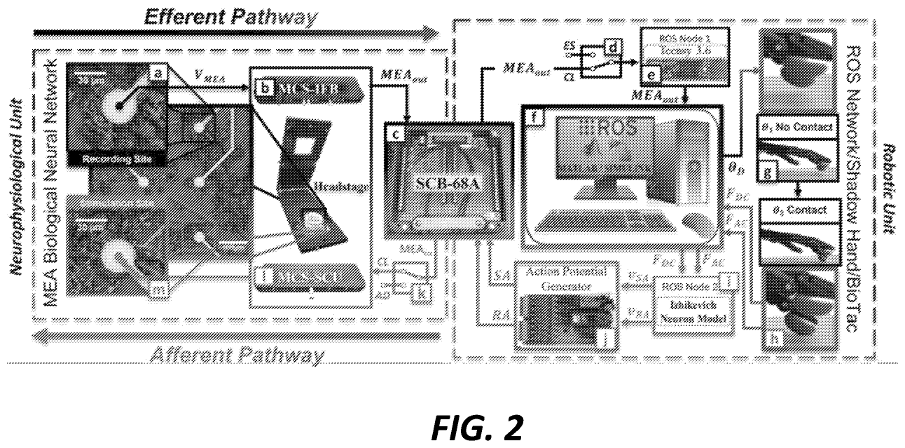

Effect of Stimulus Pattern on Neurorobotic Behavior: To investigate the NeuroRobotic behavior and functional specialization of this evoked neural information, the Inter-Tap-Interval (ITI) of the fingertip was analyzed for both SA (FIG. 3, panels b-i) and RA (FIG. 3, panels f-i) CL experiments. The ITI represents the time interval between finger taps initiated by neural activity. The timestamps of each neurotactile event, MEAₒᵤₜ(FIG. 3, panels c-g) was extracted, and the time interval between each event, represented as the ITI, was calculated.

For each embodiment session (AD, ES, CL), MATLAB was used to perform a one-way unbalanced ANOVA between the ITIs of each RA and SA encoding method. This was done for each of the DIVs. This was used to determine if the RA and SA tactile encoding methods significantly impacted the embodied behavior for each of the embodiment sessions, represented through their tapping rate, ITI.

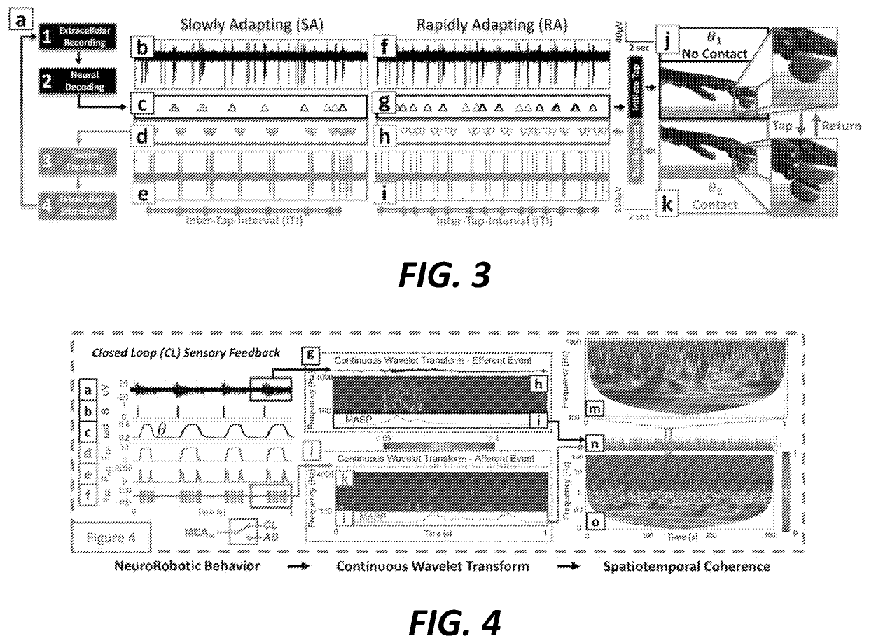

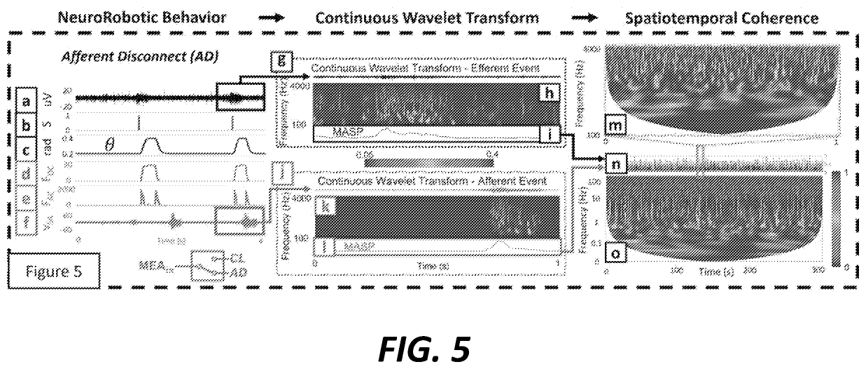

Spatiotemporal Analysis of Neurorobotic Behavior: Each embodiment session was analyzed from 2 relative perspectives: first, the macroscale for viewing each 5-minute session (FIG. 4, panel o; FIG. 5, panel o) and second, the microscale for viewing each neurotactile RA or SA event (FIG. 4, panel m, FIG. 5, panel m). The aim here was to observe the ability of the BNN to elicit different behaviors given different stimulation patterns during CL (FIG. 4, panels a-f) and OL paradigms (FIG. 5, panels a-f).

The analysis is based on a universal frequency domain by transforming the raw neural waveform into its frequency components, extracting the information in meaningful frequency bands, and evaluating the spatiotemporal wavelet coherence between afferent and efferent sites within the culture during the embodiment sessions.

Continuous Wavelet Transform (CWT) for Neurotactile Event Detection: For a robust event detector that worked across multiple datasets, a CWT was chosen to process the efferent and afferent signals (FIG. 4, panel g; FIG. 4, panel j; FIG. 5, panel g; FIG. 5, panel j). Data were processed through the CWT using a complex Morlet 1-1 as the wavelet type (WT), cmor1-1 in MATLAB, for extracting the mean amplitude-squared power across time (mASPₜ) for multiple frequency bands (FIG. 4, panel i; FIG. 4, panel 1; FIG. 5, panel i; FIG. 5, panel 1).

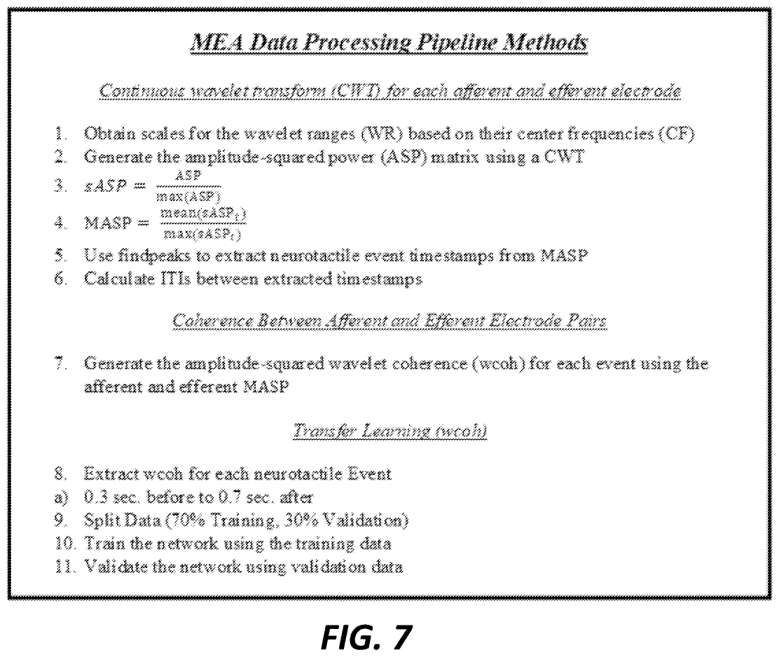

First, the scales for the WT were obtained based on the center frequencies (CF) within a designated wavelet range (WR) of 100-4000 Hz (FIG. 7) [124, 125]. Next, the absolute value of the continuous wavelet transform was squared to obtain the amplitude-squared power (ASP) for the selected frequency ranges (FIG. 4, panel h; FIG. 4, panel k; FIG. 5, panel h; FIG. 5, panel k). ASP was scaled by dividing all values by the maximum value, obtaining a scaled range, sASP, of 0 to 1 and adjusted the range to eliminate artifacts (0.05-0.4 in this case). Following this, the mean of sASP was taken across time and frequency to obtain mASPₜ (FIG. 4, panel I; FIG. 4, panel 1; FIG. 5, panel i; FIG. 5, panel 1). mASPₜ was smoothed using a moving mean function (movmean in MATLAB) with an averaging window of 50 ms. Finally, mASPₜ was scaled by dividing all values by the maximum value, obtaining a scaled range of 0 to 1.

A peak detection algorithm (findpeaks) was deployed in MATLAB to extract the timestamps of peaks exceeding a threshold of 0.5 with a minimum peak distance of 0.5 seconds to avoid multiple local maxima.

CL Connectivity Shows Spatiotemporal Coordination: Wavelet coherence was used to provide a picture of how the amplitudes of BNN activity at two spatial locations (recording and stimulating electrodes) coordinated at different frequencies over time (FIG. 4, panels m-o, FIG. 5, panels m-o). This process was completed extracting the smoothed mASPₜ for both the afferent and efferent sites. For the embodiment sessions containing 5 minutes of data, the smoothed mASPₜ was down-sampled from 20 k Hz to 2 kHz to reduce the computational expense while preserving the spectral information needed for further analysis (FIG. 4, panel n, FIG. 5, panel n). For the individual neurotactile events (FIG. 4, panel m; FIG. 5, panel m), the 20 kHz sampling rate was maintained as it was not computationally expensive.

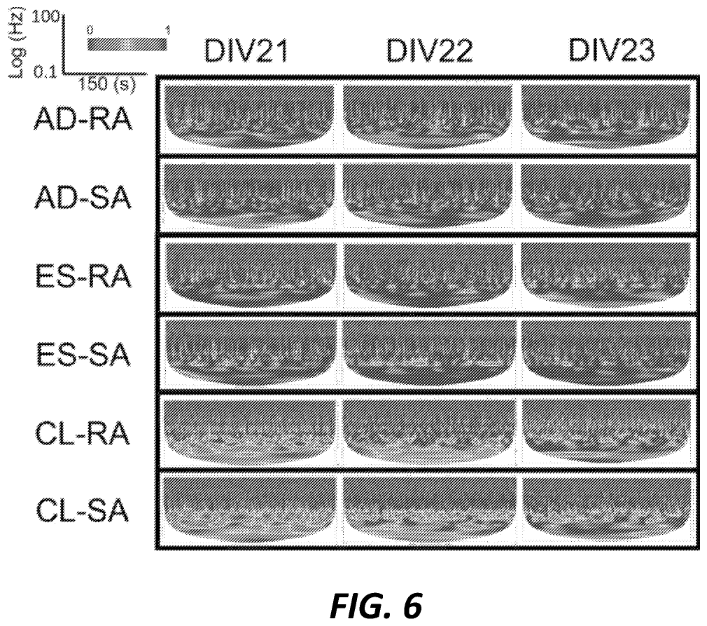

Embodiment Sessions: States of the Peripheral Neural Pathways (Macro Scale View): For each of the 3 embodiment sessions per DIV (AD, ES, CL) a mASPₜ was extracted for the afferent and efferent sites and processed through the wavelet coherence algorithm (FIG. 7). These frequency-time representations were compared across each other to obtain the coherence level for the 5-minute duration of each embodiment session (Wcoh, FIG. 4, panel o; FIG. 5, panel o; FIG. 6). Wavelet coherence was calculated with a function in MATLAB using the wcoh function. The amplitude-squared wavelet coherence generated from the smoothed mASP_{t,Aff} and mASP_{t,Eff}. A cone of influence (COI) was used to eliminate ASP data affected by edge conditions with lower frequencies at smaller timescales. The wavelet used was an Analytic Morlet Wavelet. This spatiotemporal coherence analysis allowed a comparison of the effects of the embodiment across multiple stimulation patterns, embodiment sessions, and days.

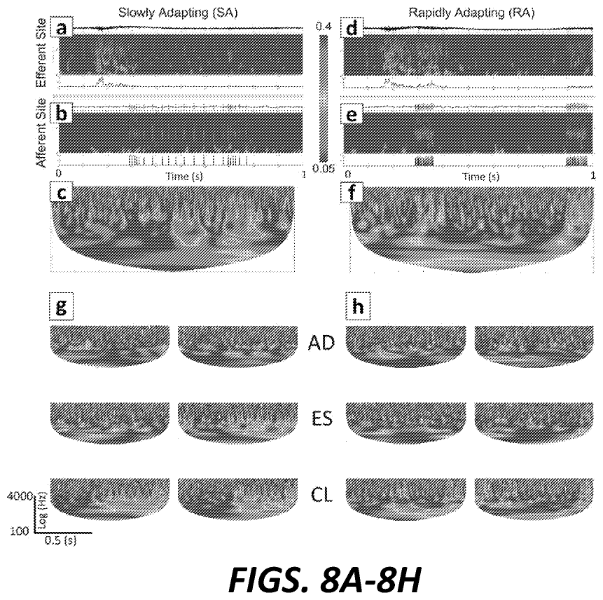

Neurotactile Events—RA and SA (Micro Scale View): For each timestamped Neurotactile event, a 300 ms segment before and 700 ms segment after each timestamp was extracted for both the afferent and efferent electrodes to make observations from the perspective of each time the BNN elicited a motor movement (FIG. 4, panel m; FIG. 5, panel m; FIGS. 8A-8H). This provided a temporally synchronized window before stimulation (efferent motor commands) and for the duration of the stimulation (afferent tactile sensations).

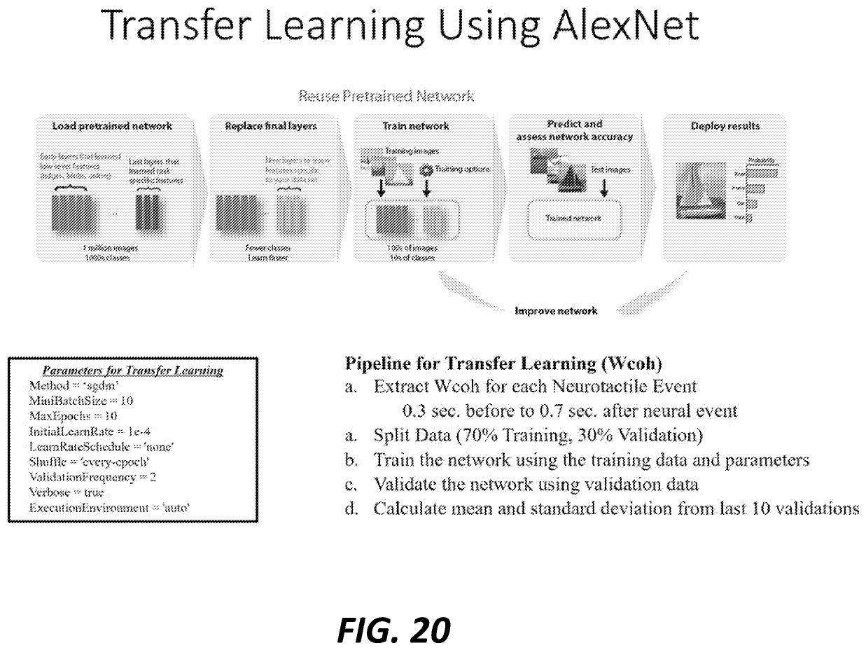

Transfer Learning with ANN to Classify EBC Activity: For each embodiment session, transfer learning of a CNN was applied to classify RA and SA neurotactile events (such as between FIG. 8H, FIG. 8F) for each DIV and every embodiment configuration (AD, ES, CL). Transfer learning used a CNN, in this case AlexNet, previously trained on millions of images. By retraining only the last three layers, the network was allowed to retain the earlier trained layers for shape, size, color, etc., and achieve high classification accuracies with only needing between 80 and 150 new images from each session. A flowchart showing a transfer learning pipeline using AlexNet including several model hyperparameters is shown in FIG. 20. The pipeline can be re-execute multiple times, e.g., at periodic time or when triggered by the system, e.g., based on detected or calculated error in the classification. Indeed, the learning algorithms are not necessarily fixed set of instructions that are stored but are constantly updated and adapted.

First, the neurotactile events for RA and SA on each DIV were extracted to train the ANN. FIG. 8G shows illustrative input data to the transfer learning program. Next, the datasets were split into training (70%, trainIMGs) and validation (30%, validIMGs). The pre-trained network was loaded, and the input size of the images was configured to be 227×227×3. Next, the last 3 layers were replaced with a fully connected softmax layer, and a classification output layer. Next, additional augmentation operations were specified to perform on the training images: randomly flipping the training images along the vertical axis, and randomly translating them up to 30 pixels horizontally and vertically. Data augmentation helped prevent the network from overfitting and memorizing the exact details of the training images. Next, the training options were specified. Once all the options were configured, the networks were trained for 10 epochs and the results of the final 10 validations were averaged.

Results Overview. Transfer of information through the noninvasive neuroprosthetic platform began when MEA efferent site activity (V_{MEA}, (FIG. 4, panel a; FIG. 5, panel a)) rose above the voltage threshold, Vₜₕᵣₑₛₕ, to trigger a spike, S (1). When S was triggered Sₜₕᵣₑₛₕ=3 times within BinSize=50 ms (2) to trigger MEAₒᵤₜ, the desired joint angle of the finger (θ_{D}) increased from θ₁ to θ₂ (3). This caused the finger joint controller to increase the joint angle (θ, FIG. 4, panel c; FIG. 5, panel c) so that the fingertip contacted the environment (FIG. 3, k), increasing the fingertip force (F_{DC}, FIG. 4, panel d; FIG. 5, panel d, (4)) and force rate of change (F_{AC}, FIG. 4, panel i, FIG. 5, panel i). Illustrative data from the SA and RA encoding of fingertip forces ((5), (6)) produced spike trains that were used to stimulate MEAᵢₙ during the CL experiments (FIG. 4, panel f). During the AD experiments, there was no stimulation of the MEA (FIG. 5, panel f). This process repeated cyclically (FIG. 3, panel a), for both SA (FIG. 3, panels b-i) and RA (FIG. 3, panels f-i) embodiment sessions, producing repetitive finger tapping behavior with variable ITI dependent on the afferent tactile encoding and configuration of the afferent and efferent control switches (FIG. 2, panel d; FIG. 2, panel k).

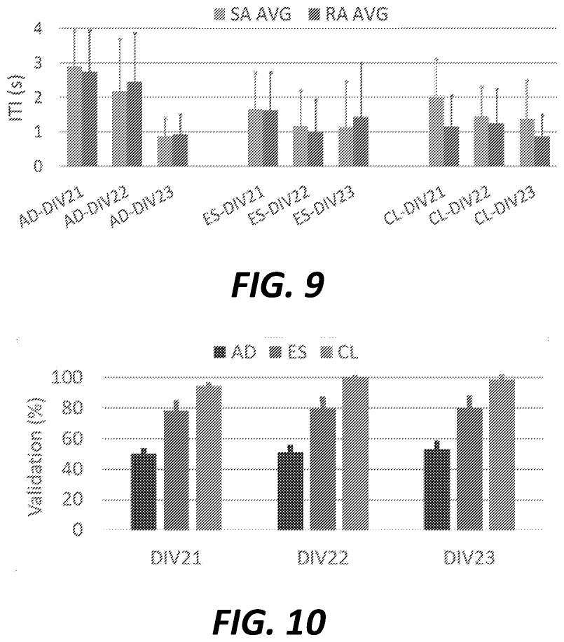

BNN Activity Impacted Robotic Behavior Results: The one-way ANOVA revealed that the RA and SA stimulation encodings significantly impacted the ITI in all CL cases (FIG. 9). The ITI of the SA encoding method was significantly longer than RA on each of the 3 days of CL experiments. The mean across all 3 days also showed a statistically significant difference (p<0.05), which is likely due to different organizations of the evoked neural activity. This indicates that the tactile information fed into the afferent stimulation site altered the BNN behaviors that the robotic hand adopted within the CL system. Or in other words, the haptic information was embodied by the neuronal cultures for functional specialization.

Also noted in the AD sessions, there was no significant difference in the tapping rates for any DIV, supporting the notion of functional specialization of the neurorobotic behavior elicited by the tactile encoding methods.

In the ES sessions, there was statistical significance on 2 of the 3 days. However, on DIV22 the ITI for SA was higher than RA and on DIV23 it was the reverse case. While there was afferent sensory feedback from the hand, there was no efferent motor control temporally coupling the afferent and efferent events. This also supports the notion that CL provides consistent functional specialization due to the spatiotemporal coupling of the afferent and efferent events.

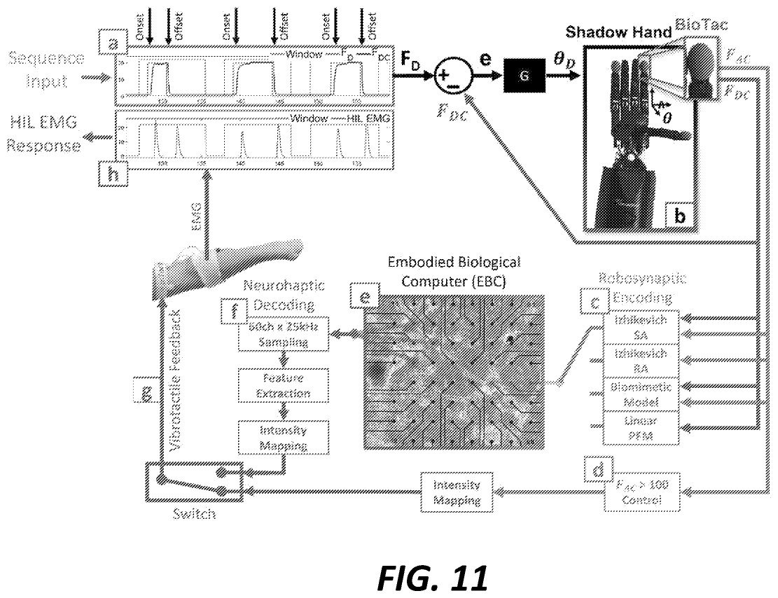

Encoding Method of Tactile Sensations Impacted BNN Activity Results: For all embodiment sessions, the transfer learning classification accuracy had a trend of increasing accuracy in the order of AD, ES, and CL. The highest accuracy was obtained via CL coupling with 100%±0% on DIV22, while the maximum ES accuracy was 79.83%±7.13% on DIV 23, and the maximum accuracy for AD was 53.19%±3.77% on DIV23 (FIG. 10).

Discussion. With the apparent difficulties and hurdles remaining for a complete clear understanding of the interplay between sensation and motor control, a bidirectional noninvasive neuroprosthetic research platform has been created that can be used to study the interaction between living BNNs and embodied robotic systems. Results showed that the encoding of tactile sensations from a robotic fingertip in an SA or RA action potential stimulation pattern impacted the behavior of the BNNs in the MEAs across multiple days. Correspondingly, the different patterns of coupled BNN activity impacted the behavior of the artificial hand in a CL fashion as evidenced by the statistically significant ITIs. By demonstrating the ability to classify the BNN patterns with ANNs, a pipeline was shown toward an online approach to classify tactile interactions through different biomimetic stimulation patterns in the embodied BNN.

The high classification accuracy and statistically significant ITIs support that the different tactile encoding methods, in this case SA and RA, impacted the BNNs' patterns of activity in a distinguishable manner that can be further explored for online classification. Looking at the classification accuracies, CL coupling demonstrated the highest separability. During ES configuration, one explanation for the increasing accuracy is the culture adapting each day to the repeated pattern where there was a consistent stimulation of 2 seconds on and 2 seconds off. Since the ES scenario does not have the synchronized coupling of the CL it is plausible that the BNN synchronized the afferent sensation with the efferent motor commands. Since these are aligning more than random chance, this suggests an adaptation in neural plasticity due to repeated behavioral conditioning.

Looking at this further, there was an expectation during ES sessions to have uncontrolled occurrences of coherence between the afferent and efferent sites due to the nature of stimulating at a fixed afferent temporal pattern, and that can synchronize with the BNNs efferent actions to go in and out of temporal alignment. With the transfer learning classifications for ES being higher than that of the AD scenarios but not as accurate as the CL scenarios, it appears as more than random alignment, and the accuracies also improved from DIV21 to DIV23. This could be explained as the culture becoming conditioned to external stimuli each day and falling into a rhythm when that pattern is presented. This warrants further investigation as this would suggest the culture is learning to interact with the environment through this type of embodiment.

### Example #3: Human-In-the-Loop (HIL) Neurohaptic Perception and Robosynaptic Embodiment

Another study was conducted after demonstrating the ability to both integrate a sensorimotor controller and provide functional specialization. This platform was expanded by integrating a human-in-the-loop (HIL) to explore the human embodiment and perception given a variety of biomimetic encoding methods currently being explored in state-of-the-art invasive neuroprostheses.

The feature of functional specialization is built on and a human into the loop (HIL) is integrated herein. It is investigated how various encoding methods of tactile interactions affect the transmission of information through the EBC to a HIL for their perception of tactile events according to the following: (1) The Shadow Robot Hand brings a BioTac tactile sensor into contact with the environment, producing tactile events; (2) Robot-to-Synapse (RoboSynapse) encodings of the tactile events produce biomimetic mechanoreceptor firing patterns for stimulation into the EBC; (3) The EBC relays functionally relevant information about the encoded tactile experience to a HIL; (4) Neurons-to-Haptic (NeuroHaptic) decoding of the evoked EBC activity provides non-invasive vibrotactile feedback to the HIL; (5) The HIL reacts to the sensory feedback using EMG signals for perception of the tactile events that occurred.

The exemplary system may be (1) coupled in a human-in-the-loop with a biological computer to investigate sensory feedback methods of tactile interaction from a dexterous robotic hand; (2) used to evaluate state-of-the-art sensory encoding methods in a non-invasive paradigm for investigating neural dynamics and human perception; (3) demonstrate RoboSynaptic embodiment of the EBC for a variety of functional modes of Neurohaptic feedback; (4) used to provide functional specialization of RA and biomimetic encodings correlated to the tactile behavioral function expected for these types of encodings, allowing increased temporal coupling of the HIL reflex responses. These encoding methods exhibited similar function to the control scenario.

### Experimental Results of Example #3

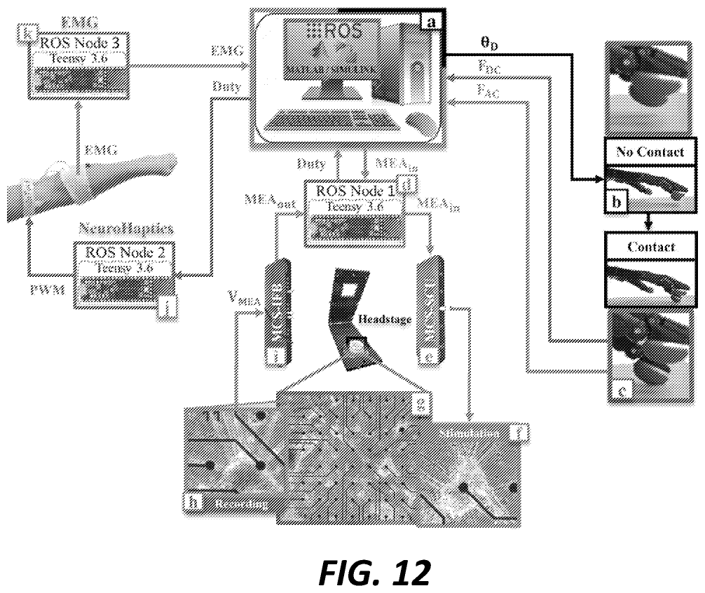

To further demonstrate this NeuroProsthetic Research platform, a human-in-the-loop (HIL) provided NeuroHaptic feedback from the non-invasive Embodied Biological Computer (EBC) (FIG. 11, panels a-i). A sequencer (FIG. 11, panel a) was mapped to a force controller for operating the Shadow Robot Hand (FIG. 11, b). Once in contact, the BioTac's tactile sensations were mapped to RoboSynaptic encodings (FIG. 11, panel c) and administered to a stimulation site in the EBC (FIG. 11, panel e). Directly evoked activity from coupled electrodes (FIG. 11, panel e) was decoded (FIG. 11, panel f) and mapped to the InTact NeuroHaptic Module including vibrotactile feedback (FIG. 11, panel g) to the subject's arm. An EMG sensor on the subject's arm collected HIL responses in the perception of the RoboSynaptic encodings (FIG. 11, panel h). For control scenarios (FIG. 11 panel d) the switch was toggled to bypass the EBC for direct vibrotactile feedback. This completed the loop, allowing investigation of the EBC's neurohaptic behavior given a variety of robosynaptic encoding methods.

Sequencing the Desired Fingertip Contact Force and Time: Three sequencers were configured in Matlab/Simulink for administering each trial to the subject. The first one indicated the Robosynaptic encoding method, the second one indicated whether to administer a control trial or a stimulation trial, and the third one was an input sequence indicating the desired force, F_{D}, over time for bringing the finger into contact with the external environment under force control for 3 different lengths of contact time: short (~2 seconds), medium (~3 seconds), and long (~4 seconds) (FIG. 11, panel a). These signals were published to the robot operating system (ROS) network.

Sensorimotor Force Control of the Dexterous Robot Hand: The neuroprosthetic system presented previously was implemented, including a Shadow Robot Hand outfit with BioTac tactile sensors. When the sensors come in contact the environment, they produce static and dynamic pressure signals, F_{DC} and F_{AC}, respectively.

Previously, the MEAₒᵤₜ signals were used to control the joint angle of the finger. In this study, control of the robot finger was transferred to the above-mentioned sequencer for controlling the desired force, F_{D}. This was realized with the following equations to minimize force error per Equations 10 and 11.

$$e = {F}_{D} - {F}_{D C} \qquad ( Eq . 10 )$$

$${θ}_{D} = θ + ( G * e ) \qquad ( Eq . 11 )$$

In Equations 10 and 11, the desired joint angle θ_{D} is governed by a controller gain, G, the previous joint angle, θ, and the error, e, between the desired force, F_{D}, and the measured force, F_{DC} (FIG. 11, panel b). Positive error creates index finger flexion, increasing θ to create fingertip contact with a surface and produce tactile forces, F_{DC} and F_{AC}, while negative error creates finger extension, decreasing θ and reducing tactile forces (FIG. 11, panel b). The measured joint angle, θ, is realized by a PID joint angle controller of the tendon-driven Shadow Hand.

Incubating The Biological Computer for Embodiment: After configuring the neuroprosthetic system, the Embodied Biological Computers (EBCs) in multielectrode arrays (MEAs) were developed for embodying the neuroprosthesis [55]. Two EBCs (labeled EBC1 and EBC2) were incubated over the course of 12-14 days. Primary cortical neurons were harvested from postnatal day 0-1 mouse pups. All animal procedures were approved by the Institutional Animal Care and Use Committee and in compliance with the National Institutes of Health Guidelines for the Care and Use of Laboratory Animals. Pups were euthanized by quick decapitation, and brains were immediately removed and placed in ice-cold dissection medium (1 mM sodium pyruvate, 0.1% glucose, 10 mM HEPES, 1% penicillin/streptomycin in HEPES-buffered saline solution). Cortex was extracted under a dissecting microscope and pooled together. The tissue was digested with 0.25% trypsin in the dissection buffer for 15 min at 37° C. followed by further incubation with 0.04% Dnase I (Sigma-Aldrich) for 5 min at room temperature. The digested tissue was triturated with a fire-polished glass pipette 10 times and cells were pelleted by centrifugation. Cells were split and plated at ~5,000 cells/mm² in a MEA-60 chamber (Multichannel systems), (FIG. 11, panel e). The culture used was BrainPhys™ neuronal culture medium (STEMCELL Technologies Inc., Vancouver, BC). Culture media was not changed for the duration of the experiment. Spontaneous structural and functional connectivity was allowed to mature for 12-14 days before beginning the bidirectional neurorobotic experiments. This was evaluated with the following protocol.

Assessing the Biological Computer—Electrode Scanning Protocol (ESP): Once ready, the connectivity and responsiveness of the EBCs was assessed by utilizing the following Electrode Scanning Protocol (ESP): (1) a 10-minute baseline recording where active electrodes with spontaneous firing activity are marked down, (2) an amplitude scan to determine the minimum stimulus amplitude for directly evoking activity with strong responses, (3) an electrode scan with a 1 Hz stimulation frequency at the amplitude selected to determine the afferent stimulation site having the maximum directly evoked efferent responses to the stimulus, and finally, (4) a frequency scan on the selected afferent stimulation site to collect data on the evoked responses at different frequencies of interest and assess the frequency responses of the EBCs.

During the ESC protocol, an assessment of the frequency responses determines the type of experiment that can be performed. Some cultures are directly responsive to input stimuli at a high rate with a 1-to-1 type of directly evoked responses to stimuli (<15 ms). Other cultures have shown a slower bursting-type evoked response (>40 ms) that requires a small refractory period after stimulation where the culture is not responsive to each new stimulus within that period. This dictates the types of experiments that can be performed and guides the selection for the paradigm evaluated. The cultures in this study exhibited the traits of the slower bursting-type responses with an average spontaneous response rate greater than 2 second.

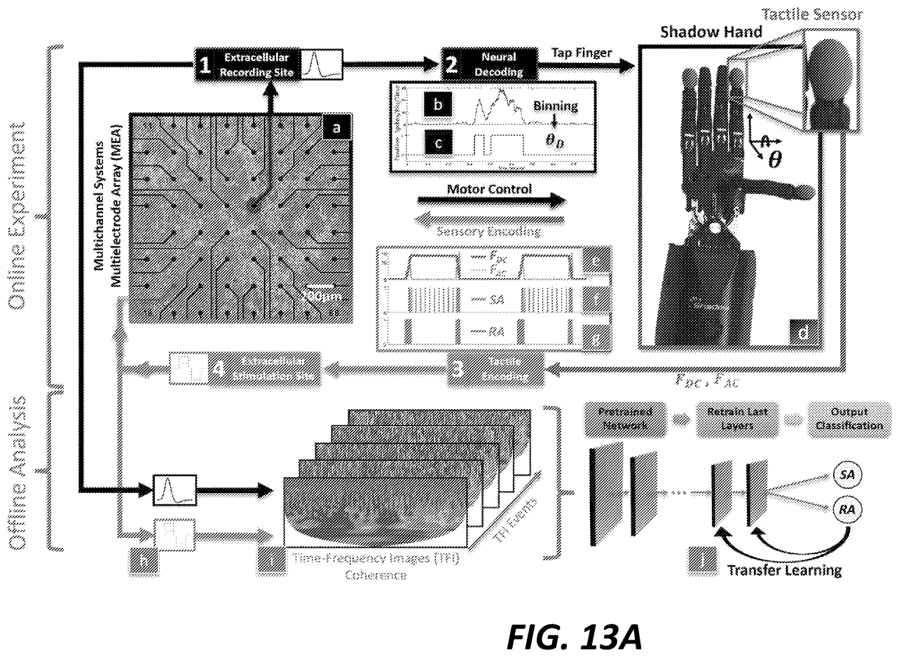

Robot Operating System (ROS): The robot operating system (ROS) was deployed in python to manage data between the various subsystems. ROS master (FIG. 12, panel a) managed data distribution between the nodes as well as the force control for sending θ_{D} to the Shadow Robot hand (FIG. 12, panel b) for producing a tactile event (FIG. 12, panel c) and generating the F_{DC} and F_{AC} signals. Three nodes were deployed: (node 1) (FIG. 12, panel d) managed the stimulation and recording from each EBC as well as decoding of the NeuroHaptics, (node 2) (FIG. 12, panel j) managed the vibrotactile feedback to the HIL, and (node 3) (FIG. 12, panel k) managed the EMG signal measurements from the HIL reactions.

Embodying The Biological Computer—Robosynaptic Encoding (BioTac->MEA) (ROS Node 1): Five different robosynaptic encoding methods were employed for administering stimulations to the EBCs (FIG. 11, panel i, FIG. 11, panel d): (0) SA and (1) RA mechanoreceptor firing patterns generated from the Izhikevich Neuron modeling for biomimetically inspired variable PFM, (2) a modified biomimetic approach modeling the aggregate firing of multiple mechanoreceptors during contact, (3) a linear PFM mapping of BioTac pressures to the variable frequency of stimulation, and (4) a control method whenever F_{AC} exceeded a threshold of 100. Note that control (4) did not stimulate the EBCs and was used to directly control the vibrotactile feedback to the subject with a duty cycle of 100% whenever triggered.

Izhikevich SA and RA—Singular Neuron Variable PFM: Equations (5-9) and Table 1 provides description of Izhikevich modeling and tuning.

Modified Biomimetic Model (MBM)—Aggregate Population Variable PFM: Similar to the Izhikevich Neuron model encoding method, the Modified Biomimetic Model (MBM) uses an integrate and fire approach. The input current is as follows in Equations 12-16.

$${I}_{Input , MBM , i} = 186 {F}_{D C , i} - 185 {F}_{D C , i - 1} + 1559 {F}_{A C , i} - 360 {F}_{A C , i - 1} - 109 {F}_{A C , i - 2} \qquad ( Eq . 12 )$$

$${I}_{Input , MBM , i} = \frac{{I}_{Input , MBM , i} + {I}_{Input , MBM , i - 1}}{500} \qquad ( Eq . 13 )$$

$${I}_{Input , MBM , i} = \{ \begin{matrix}α if {I}_{Input , MBM , i} \geq α \\ {I}_{Input , MBM , i} if {I}_{Input , MBM , i} < α\end{matrix} \qquad ( Eq . 14 )$$

$${Fr}_{MBM , i} = {Fr}_{MBM , i - 1} + z * {I}_{Input , MBM , i} \qquad ( Eq . 15 )$$

$$if {Fr}_{MBM , i} \geq δ , then \{ \begin{matrix}{Fr}_{MBM , i} ← γ \\ {MEA}_{i n} = 4.5 V for 1 ms\end{matrix}$$

$$else \{ \begin{matrix}v ← v \\ u ← u \\ {MEA}_{i n} = 0 V\end{matrix} \qquad ( Eq . 16 )$$

In Equations 12-16, the input current, I_{Input,MBM,i}, is calculated for each timestep, i, using F_{DC} and F_{AC} for the i, i−1, and i−2 timesteps. This is scaled and saturated at α=25 if the value exceeds the threshold, α=25. Finally, I_{Input,MBM,i} is added to the previous MBM firing rate, Fr_{MBM,i-1}, each iteration. z is a scaling factor and was set to z=2 for these experiments. When Fr_{MBM,i} exceeds the threshold δ=30, a 1 ms pulse is sent to MEAᵢₙ and Fr_{MBM,i} is reset to γ=−55.

Linear PFM: The following mapping was deployed to convert the input force, F_{DC}, into a firing rate per Equation 17.

$${Fr}_{Linear} = \{ \begin{matrix}- 3096.8 {F}_{D C} + 103097 if {F}_{D C} \geq σ \\ 0 if {F}_{D C} < σ\end{matrix} \qquad ( Eq . 17 )$$

In Equation 17, σ is the threshold for minimum F_{DC} value before firing a pulse. For this case, σ=1.5. Fr_{Linear} is in units of microseconds and represents the time between desired spike output. This uses the internal clock of the teensy 3.6 to output a 1 ms digital high signal, MEAᵢₙ, when the timer exceeded Fr_{Linear}.

F_{AC}>100 (Control—No EBC Stimulation): To provide the control scenario, the following relationship was programmed for direct vibrotactile feedback from the BioTac signals per Equation 18.

$${PWM}_{Control} = \{ \begin{matrix}255 if ( {F}_{A C} > ϵ ) \\ 0 if ( {F}_{A C} < ϵ )\end{matrix} \qquad ( Eq . 18 )$$

In Equation 18, PWM_{control} is the pulse width modulation output value and E is the threshold for controlling the vibrotactile feedback. Whenever the dynamic force, F_{AC}, exceeded ϵ=100, the vibrotactile feedback was set to a PWM_{Control}=255. This represented a maximum intensity of vibrotactile feedback during the satisfied cases.

A python script was written to convert the F_{DC} and F_{AC} signals into their respective PFM signals from the encoding methods outlined above. These PFM signals were published to the ROS master (FIG. 12, panel a). A teensy 3.6 was used as ROS Node 1 (FIG. 12, panel d) for stimulating the EBC (FIG. 12, panel g). ROS Node 1 is programmed to send a digital high output signal to the MCS-SCU (FIG. 12, panel e) for triggering a stimulus pulse to the stimulation site (FIG. 12, panel f) within the EBC (FIG. 12, panel g) for each encoded Robosynaptic stimulation (FIG. 11, panel d).

Perceiving The Biological Computer—NeuroHaptic Decoding (MEA->Evoked Response) (ROS node 1): From the 60 available channels (1 for ground), the efferent electrode in the ESP with optimal responses to the afferent stimulation site is chosen for RT feedback output. Features were extracted from this coupled electrode and mapped to digital outputs on the MCS-IFB for controlling the intensity of the NeuroHaptic module on the subject's arm.

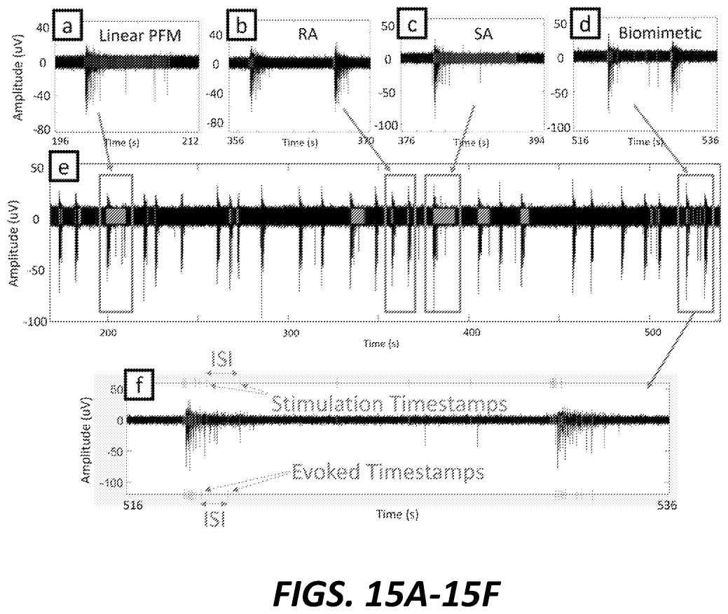

FIGS. 15A-15F shows the pipeline for feature extraction of each robosynaptic encoding. This included (1) a 100 Hz 4^{th} order Butterworth highpass filter followed by (2) threshold-based spike detection with a standard deviation of 5.5 for extracting spike timestamps (FIG. 15F), and (3) triggering a digital TTL output of 1 ms for evoked activity within a 5 ms window. (4) This was sent to the digital inputs of a Teensy 3.6 (ROS node 1) for modulating the vibrotactile frequency of the InTact NeuroHaptic feedback module worn on a subject's limb.

Vibrotactile Feedback Mapping Methods (Evoked Responses->NeuroHaptic Feedback) (ROS Nodes 1 and 2): ROS Node 1 also managed data collection from the EBC. The outputs of the MEA MCS-IFB that were connected to digital input pins on the teensy 3.6 were configured as digital interrupts. Rising edge detections triggered an interrupt service routine (ISR) to adjust the intensity of vibrotactile feedback applied to the subject. For each detected spike, the inter-spike intervals (ISI) were calculated for the instantaneous firing rate of the evoked responses. This value was mapped to a duty cycle and published to the ROS master for controlling the instantaneous intensity of the vibrotactile feedback administered to the NeuroHaptic Module worn on the subject's arm.

To achieve a linearly perceived sensation, the signals of the duty cycle were mapped using a square root function [126] per Equation 19.

$$Weber = \sqrt{Duty} \qquad ( 19 )$$

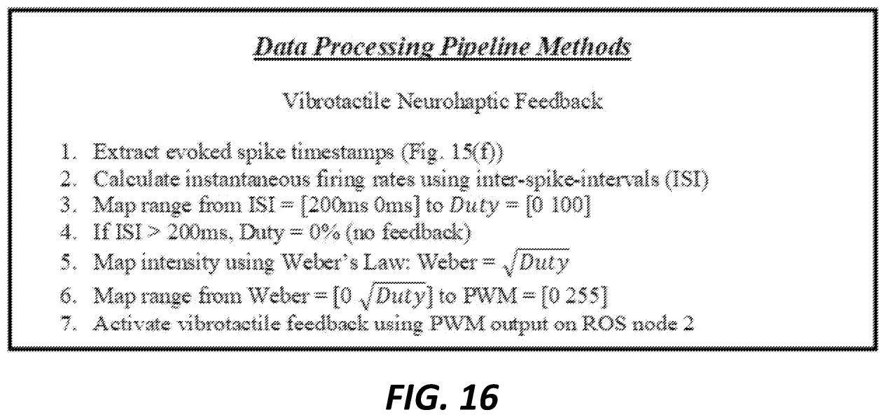

After mapping the duty cycle, Duty, the Weber values were scaled to a range of 0<PWM<255. ROS Node 2 was configured to subscribe to the duty cycle from ROS node 1 for administering vibrotactile feedback to the InTact module on the subject's arm. The duty cycle was converted to PWM and provided vibrotactile feedback to the subject (FIG. 16).

Human-In-The-Loop EMG Responses (NeuroHaptic Feedback->HIL EMG Response) (ROS node 3): An EMG sensor was placed on the residing limb of the subject and connected to a teensy 3.6 configured as ROS node 3 (FIG. 12, panel k). This published EMG signals to the ROS master (FIG. 12, panel a) for HIL EMG responses (FIG. 12, panel k, FIG. 13A) to the NeuroHaptic feedback (FIG. 12, panel j, FIG. 13A).

Experiment Protocol—HIL Perception and Biological Computer Embodiment. Six subjects, 3 male and 3 female, split across 2 EBCs were trained and tested. 1 male subject had a left-handed congenital transradial absence and 5 subjects had intact limbs. Subjects 1-3 were assigned EBC1 and subjects 4-6 were assigned EBC2. Each subject went through three stages for embodying the NeuroHaptics and perceiving the three different tactile contact times: (1) control training, (2) control testing, and (3) NeuroHaptic Testing. The first stage (1) was to train the subject with a control scenario that bypassed the EBC and provided direct vibrotactile feedback to the subject from the thresholded F_{AC} signals of the BioTac (FIG. 11, panel d). Once the subject felt comfortable, they were tested (2) on 30 random trials to assess their performance. Performance above 80% proceeded to the NeuroHaptic testing (3), where the BioTac signals were connected to the RoboSynaptic Encoder for evoking the EBC to relay NeuroHaptic information to the HIL. NeuroHaptic testing was performed in 3 sets of 50 trials. The subjects were retrained in between each set of 50 to reacclimate to the control scenario. The entire session varied from ~1.25-2 hours per subject.

NeuroHaptic Training Protocol: Each session started with the subject taking a seat and placing the vibrotactile actuator and EMG modules on the subject's arm. During training, a computer screen in front of the subject displayed 4 pieces of information (FIG. 11, panel a, FIG. 11, panel h): a sequence indicating a window of time where the finger would contact the environment, another sequence indicating the desired force, F_{D}, to control the finger contact length of time with the environment, the BioTac force measurement, F_{DC}, and the EMG measurements from the subject's arm. The sequence controlling the finger contact length of times was randomly placed within the first window to minimize the subject's ability to predict the onset.

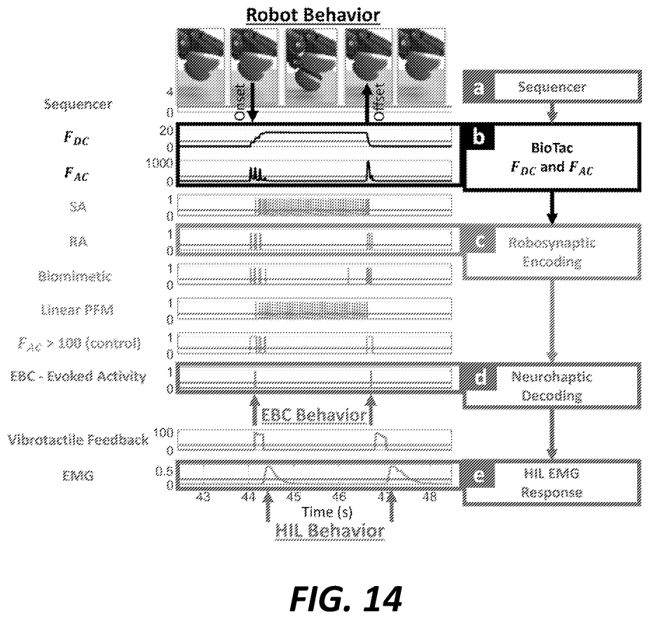

Each subject was first trained to embody the vibrotactile feedback with the control scenario (FIG. 11, panel d). The sequencer (FIG. 11, panel a) brought the robotic finger into contact with the external environment under force control for 3 different lengths of contact time: short (~2 seconds), medium (~3 seconds), and long (~4 seconds). F_{AC} signals above 100 units (FIG. 11, panel d) were used as a control scenario for providing haptic feedback to the subject for the onset and offset (FIG. 11, h) of the tactile contact. The computer screen provided a live stream of the force, F_{DC}, measured by the BioTac (FIG. 11, panel a). The subject was instructed to produce an EMG signal (FIG. 11, panel h, FIG. 13A) whenever they felt the vibrotactile feedback (FIG. 14, panel d), indicating their perception of the onset and offset of the finger's contact with the environment (FIG. 14, panel a). The subject was afforded up to 150 practice trials to become familiar with and integrate the vibrotactile feedback. This trained the subject to mentally perceive the 3 different applied BioTac contact lengths using the vibrotactile feedback of the NeuroHaptic module.

Pseudorandom Distribution of Experiment Trials: A total of 150 NeuroHaptic testing trials were deployed per subject, distributed among 5 stimulation encoding methods and 3 tactile contact lengths. Upon completion of all 150 trials, 7 repetitions of each permutation were randomly selected to provide 105 evenly-distributed pseudorandom trials per subject.

Relative Response Time (RRT) Analysis—Cross-Correlogram: The ability of the EBC to relay tactile information to the HIL was evaluated for different RoboSynaptic Encoding methods. A cross-correlogram was deployed to evaluate the relative response timing (RRT) between cause and effect. In this case, there were 2 pipelines of analysis: (1) the ability for the EBC to provide an evoked response given a RoboSynaptic encoded stimulation, and (2) the ability of a HIL to perceive vibrotactile feedback from various NeuroHaptic encodings and react to them.

To achieve this, the timestamps were extracted for each of the signals in FIG. 14, panels a-e as was done in chapter 3. For analysis pipeline (1), each stimulus timestamp at the stimulation site (FIG. 12, panel f) in the EBC was compared to the timestamps of the evoked activity at the recording site (FIG. 12, panel h). This provides a relative correlation between a stimulated event and the EBC's ability to provide an evoked response at the recording site. The directly quantifies the temporally evoked responses.

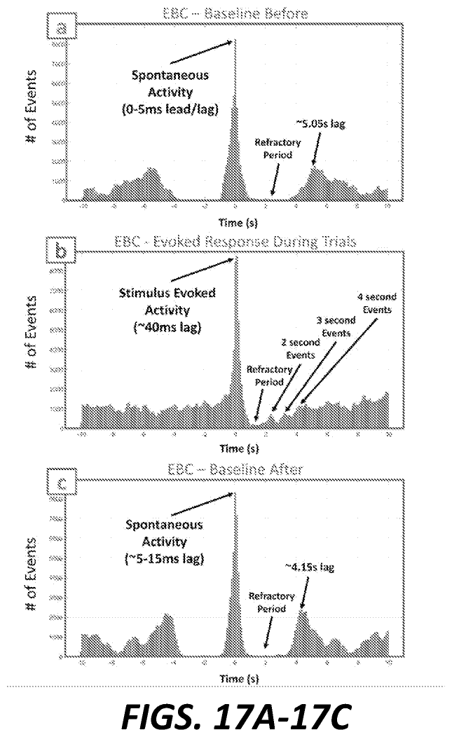

Robosynaptic Encoding Methods Affect NeuroHaptic Behavior Results: FIGS. 17A-17C show the evoked response comparison from before experimentation, during HIL experiments, and after the experiments were completed. This demonstrated the ability to obtain directly evoked responses from the biological computer for a variety of stimulation encoding methods. The baseline spontaneous activity before stimulation sessions (FIG. 17A) showed approximately 0-5 ms lead/lag correlation between the stimulation and recording electrode sites. Additionally, the baseline activity showed a natural refractory period of approximately 5.05 seconds between activities. During stimulation sessions, the mean evoked response time (FIG. 17B) changed to ~40 ms with satellites at the 2.4, 3.4, and 4.4-second marks. This corresponds to the 2, 3, and 4-second contact lengths administered from the sequencer during the experiments, suggesting that there are temporal modalities achieved in the functional specialization of the culture.

Observation of the ~4-5 second refractory in the period of the baseline before and after stimulation experiments (FIG. 17A, FIG. 17C) supports the type of culture response that dictated the type of experiment that can be performed.

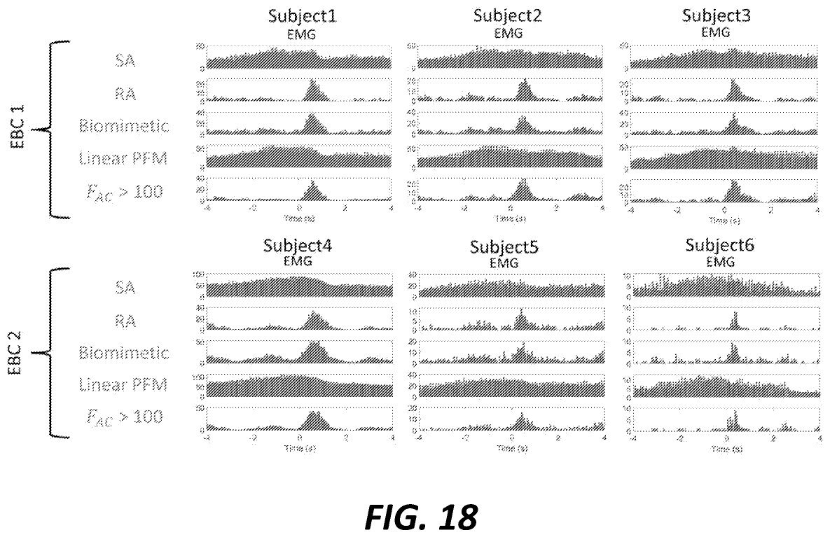

Encoding Methods Support Tactile Transmission of Biological Modalities Closed-Loop HIL Reaction Time: After demonstrating the EBCs ability to provide evoked responses, the temporal correlation was shown between the encoding methods and the HIL EMG (FIG. 18). Each column-row pair is a cross-correlogram between the encoding method (rows) and the HIL EMG (columns). The RA and biomimetic groups more closely resembled the responses of the control group for recognizing onset and offset events. SA and linear PFM consistently missed the offset, correlating to the function of SA and Linear PFM relating to static pressure in the other types of culture dynamics seen in different cultures with the higher frequency responses found during the electrode scanning protocol (ESP). FIG. 18 shows the EMG reaction times for the HIL responses to the neurohaptic feedback relayed through the EBC from the robosynaptic encodings.

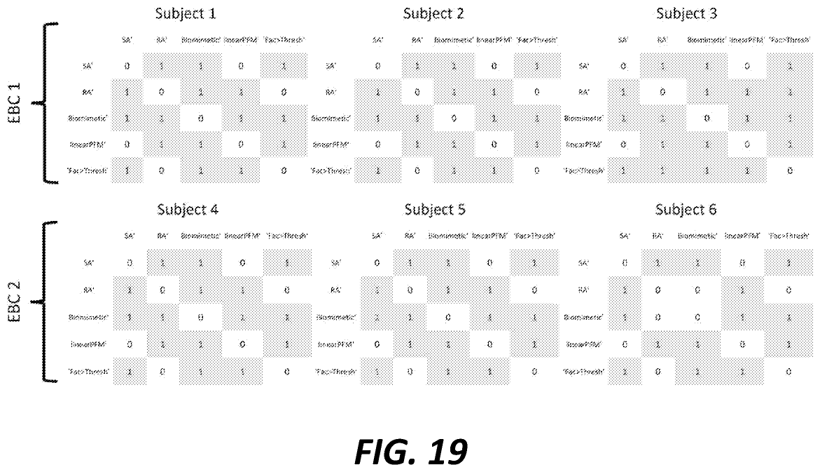

Two-sample Kolnogorov-Smirnov goodness-of-fit hypothesis test: FIG. 19 shows the two-sample Kolmogorov-Smirnov goodness-of-fit hypothesis test, representing the temporal correlation between robosynaptic encoding methods and HIL EMG responses from the cross-correlation datasets shown in FIG. 18. This provides a statistical measure of whether the distribution of each dataset is from the same distribution or different distributions. Values of “1” represent a different distribution and a value of “0” represents the same distributions. This test was used to analyze the similarities and differences between different encoding methods and the HIL EMG responses they evoked through the EBC.

The results for subjects 1, 2, 4, and 5 show that the distribution of the RA encoding method was similar to the control case, while the SA and linear PFM cases were not. This aligned with the original hypothesis for the functional specialization associated with these types of encodings and their respective function. Also note, the final session for both EBC1 and EBC2 (subject 3 and subject 6) had different results when compared to the first 2 sessions for each EBC (subjects 1, 2, 4, and 5). There could be a few explanations for this: (1) the cultures were approaching the end of their functional efficacy, so this could explain the mismatch observed in each case, (2) the cultures were learning something that took a few sessions to integrate into its function, (3) it could be due to different subjects and something associated with their performance, (4) there could be a natural effect from the DIV the session was on. In addition to these, note that there are no cases where the RA was similar in distribution to SA or linear PFM, regardless of the above-mentioned factors. This demonstrates that the cultures have the ability to achieve the functional specialization hypothesized in a biomimetically appropriate correlation to the biological function of RA and SA type tactile modalities.

Discussion Disclosed herein is a non-invasive human-in-the-loop neuroprosthetic research platform and demonstrated the ability to directly evoke neurohaptic responses from an EBC with encoding-specific functional specialization. Sensory encoding methods were evaluated in a non-invasive paradigm for investigating neural dynamics and human perception. The functional specialization of RA and biomimetic encodings being correlated to the type of tactile behavior expected for detecting discrete events like onsets and offsets of tactile contact were demonstrated, similar in function to the control scenario.

Following their suit, the discrete tactile event experiments outlined in [127-129] were recreated with all subjects having greater success for the discrete events than for those associated with linear PFM and SA encoding methods. Subjects performed better than chance in discriminating the onsets and offsets of tactile interaction with the environment when relayed through the EBC. This paradigm combined invasive encoding methods with non-invasive haptic feedback methods and subjects were able to distinguish 3 levels of contact time with encoding methods affecting their ability to perceive the correct onsets and offsets.

The EBC was consistently able to provide an evoked response with a temporal delay of approximately 40 ms. This was successfully able to provide haptic feedback to each subject. They were able to respond to the stimulus-evoked events with a reaction time ranging from 250-500 ms.

Subjects 1, 2, 4, and 5 all had similar distributions in their EMG responses to the encoding methods. They showed the RA to be similar to the control and dissimilar to the linear PFM, biomimetic, and SA. Conversely, subjects 3 and 6 showed a slightly different results when comparing the biomimetic and the control methods to the RA encoding. Some potential explanations that could have played a role include the subjects being different, the DIV being different, and the culture being different.

Note that for all subjects, the RA was not similar in distribution to either the SA or the linear PFM encoding methods. This is consistent with the observations from the culture dynamics mentioned earlier about the type of experiments that can be performed and that different cultures provide different response rates. This could result in different functional specializations and different modalities available for interaction.

Further experiments can benefit from a richer decoding of the evoked responses as this study only detected the ITI values for mapping to the NeuroHaptic module. The response for the culture in this HIL experiment exhibited a slower bursting-type response across multiple electrodes. Other culture dynamics could support SA and linear PFM modalities for detecting force levels, for example. As only a single electrode was used for decoding in this experiment, there is more information available from multiple electrodes to decode the relative spike timing across the EBC. Additionally, the evoked bursting may provide temporal spiking patterns not explored in this study.

The exemplary system and method can enhance invasive sensorimotor algorithms that are optimized in a non-invasive paradigm prior to patient integration. Combining this with artificial neural networks and other forms of advanced machine learning tools can provide natural and customized sensory restoration that can learn over time to integrate with the patient's neural signature for the next generation of neural interfaces.

### Discussion and Additional Considerations

The instant neuroprosthetic research platform provides a non-invasive model for investigating sensorimotor interactions between the encoding and decoding of state-of-the-art invasive neuroprosthetic solutions.

To investigate neuroprosthetic solutions in the past, a human being had to undergo a surgical procedure. Surgeons implanted an electrode interface to investigate how a patient's nervous system responds to and interacts with an artificial prosthesis. The former case required extensive regulatory approval and time that has bottlenecked the advancement of this field.

In contrast, the non-invasive human-in-the-loop neuroprosthetic research platform presented in this dissertation was able to investigate closed-loop sensorimotor encoding and decoding of tactile interactions comparable to the invasive neuroprosthetic efforts, but without an invasive surgery, lengthy regulatory approval, and the experiment in chapter 4 was achieved in 24 days. This model can be duplicated, and multiple EBCs connected in parallel to increase the throughput rate and explore multidimensional interactions.

It was demonstrated that the sensory integration for an SMA finger can provide excellent disturbance rejection. This actuator provided a function in a non-submerged environment with an antagonistic controller design that can mimic the function of antagonistic muscle groups and reduced the control complexity.

Upon demonstrating the importance of sensation in the control loop, the study substituted the experimental SMA finger with a commercially available artificial hand (Shadow Robot Hand) outfit with tactile sensors (Biotac) and coupled this to a living biological neural network grown in a multielectrode array (MEA) dish. The goal was to investigate the sensorimotor behavior of such a coupled system when exposed to biomimetically accurate encoding methods of rapidly adapting (RA) and slowly adapting (SA) mechanoreceptor firing patterns. Does the encoding method provide functionally specific behavior? To investigate this, analysis tools and a pipeline were developed for investigating spatiotemporal coordination between afferent and efferent electrode interface locations. This was demonstrated to have functional specialization by using transfer learning to train a CNN to decode the input stimulation type that resulted in the finger tapping behavior exhibited.

Upon completion of the experiment, it was shown that a Biological Neural Network (BNN) can be developed, interfaced with, and maintained for use as a closed-loop research platform to investigate sensorimotor interactions. It was shown that closed-loop (CL) sensorimotor coupling showed an increase in spatiotemporal coordination compared to AD and ES. Additionally, it was demonstrated that CNNs can be used to classify between tactile encoding methods. These tactile encoding methods of RA and SA patterns elicited different behaviorally functional specialization from the BNN, shown with statistically significant ITIs.

By this stage, the ability to couple a living biological neural network to an artificial dexterous hand in-vitro and provide functional specialization of the behavior through encoding methods was shown. The next step was to build upon the feature of functional specialization and integrate a human into the loop (HIL). This was done to investigate how various encoding methods of tactile interactions affect the transmission of information through the EBC. This transmission was used to evaluate a HILs ability to accurately perceive the modalities of the tactile events.

To do this, a Shadow Robot Hand brought the BioTac tactile sensor into contact with the environment, producing tactile events. Next, Robot-to-Synapse (RoboSynapse) encodings of the tactile events produced biomimetic mechanoreceptor firing patterns for stimulation into the embodied biological computer (EBC). The EBC relayed functionally relevant information about the encoded tactile experience to a HIL. Neurons-to-Haptic (NeuroHaptic) decoding of the evoked EBC activity provided non-invasive vibrotactile feedback to the HIL. Finally, the HIL reacted to the sensory feedback using EMG signals for the perception of the tactile events that occurred. The relationship between input stimulations and the evoked activity was compared for cases of baseline, during embodiment sessions, and after the sessions were complete. This showed that there was a temporal relationship during stimulations that was not present during the baseline and after sessions. This demonstrated the ability of the stimulation to provide a direct response that could be used for relaying functionally specific information to the HIL. Additionally, the relationship between the robosynaptic encoding methods and the HIL EMG responses to the EBC-relayed vibrotactile feedback was evaluated. A two-sample Kolmogorov-Smirnov goodness-of-fit hypothesis test showed the similarities between the RA and control methods for 4 of the 6 subjects, while there was never a case where the RA or the control method were similar to the linear PFM or SA encoding methods. This supports the functional-specific modalities of these mechanoreceptor types in behavior.

Ultimately, investigated herein was the fundamental components of the human sensorimotor system, where biological matter has formed structures in such a way to produce varying levels of behavioral function. The nervous system is constructed using many combinations of these fundamental components, entangled and superimposed over one another to produce the incredible qualities attributed to human behavior. The brain can be exemplified as an extremely efficient system, which nature has evolved to function on sparse representations. These sparse codes allow the extraordinary management of encoding and decoding the environment in which one exists.

In addition to the AI models discussed above, other AI models can be used.

Machine Learning. The exemplary system and method can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as a feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., an error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by down sampling). A fully-connected layer includes neurons, where each neuron is connected to all of the neurons in the previous layer. The layers are stacked similarly to traditional neural networks. GCNNs are CNNs that have been adapted to work on structured datasets such as graphs.

The term “generative adversarial network” (or simply “GAN”) refers to a neural network that includes a generator neural network (or simply “generator”) and a competing discriminator neural network (or simply “discriminator”). More particularly, the generator learns how, using random noise combined with latent code vectors in low-dimensional random latent space, to generate synthesized images that have a similar appearance and distribution to a corpus of training images. The discriminator in the GAN competes with the generator to detect synthesized images. Specifically, the discriminator trains using real training images to learn latent features that represent real images, which teaches the discriminator how to distinguish synthesized images from real images. Overall, the generator trains to synthesize realistic images that fool the discriminator, and the discriminator tries to detect when an input image is synthesized (as opposed to a real image from the training images).

As used herein, the terms “loss function” or “loss model” refer to a function that indicates loss errors. As mentioned above, in some embodiments, a machine-learning algorithm can repetitively train to minimize overall loss. In some embodiments, the personalized fashion generation system employs multiple loss functions and minimizes overall loss between multiple networks and models. Examples of loss functions include a softmax classifier function (with cross-entropy loss), a hinge loss function, and a least squares loss function.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

Additional Applications: Now that there is an established platform and analysis pipeline the closed-loop realtime feedback can be used for a variety of applications including, but not limited to, functional incubation, integration, and neurorehabilitation.

A Matlab interface can be developed to increase capabilities from 2 stimulus inputs and 1 RT feedback output to having access to the raw signals from all 60 channels in the MEA. Additionally, this interface can provide a wider suite of control over the electrode selections for stimulation during an experiment, opening the doors for more complex experiments.

An MEA tool, “MEAssistant”, can also be developed to aid in the real-time evaluation of these embodied biological computers. Beyond the access to all 60 channels, this platform can be improved by implementing an automated approach that quantitatively determines if convergence criteria are met or not instead of the subjective approach taken here of manually observing and deciding which electrodes had evoked responses. This can provide a more objective measure of the quality of the selected electrode(s).

After implementing an automated ESP protocol, it would be beneficial to explore the real-time integration of a deep reinforcement learning paradigm to explore the natural neural patterns that emerge from closed-loop reinforcement learning of a living Embodied Biological Computer.

Additionally, the MEA2100-multiwell system and the CMOS-5000 system from Multichannel Systems can be employed. With these platforms, a broader range of inquiries can be evaluated as the multiwell has 24 chambers that can be accessed simultaneously in parallel through the Matlab interface that has been developed. The CMOS-5000 can also be interfaced with Matlab for streaming the data.

There have also been tremendous advancements in the feasibility of psychoactive compounds such as LSD, DMT, psylocibin, and other forms of drug interactions to provide neuritogenesis, spinogenesis, and other forms of beneficial properties promoting functional and structural neural plasticity [131]. These may have beneficial impacts on the restoration of a severed neural system like that in an amputation. This type of platform can provide an alternative model for performing this type of drug interaction research while eliminating the risk to patients.

The exemplary method may be employed for medical evaluation that narrow the gap between objective and subjective treatments of mental illness, degenerative nerve diseases, etc. Providing 'round-the-clock cloud-connected medical analysis would eliminate waste for medicine and provide a more targeted approach to health care for the future of mankind.

Past research has shown that there is a fundamental encoding present in the sensorimotor system to represent the world [1-5]. With this platform, the natural encoding of tactile interaction can be explored by coupling the EBC with a reinforcement learning paradigm for sparse coding to investigate if there is a natural order to the encoding of sensation and how this is dependent on the state of the system for which it is interacting. Do static and dynamic forces get encoded in the way slowly and rapidly adapting mechanoreceptors are modeled? This could bring research one step closer to unraveling the relationship between interactions that produce sensation and the natural behavioral mechanisms that ensue.

Note that this isn't limited to tactile interactions. These natural behavioral mechanisms from one neural field to another are the fundamental components of each of the systems one has access to: memory, cognition, emotion, etc.; building up the hierarchical chain from the cellular level all the way to the behavioral level exhibited through one's body.

This study looked at the electric properties. The exemplary method and system may be reviewed for other fields: thermal, fluidic, visual, etc. In each of these forms, the measurements made to observe them are of a digital form to display them on the computer screens for viewing.

Another important part of this is to have a system that encompasses both domains continuously.

Beyond the scope of this study, approaches like this can evolve and mature into a more accurate method for generating and decoding neural stimulation patterns that provide regenerative properties to traditional medical treatments (neural degenerative diseases, mental illness, pacemakers, etc.). Additionally, this approach can be coupled with generative adversarial networks and begin providing a mental image for coupling the user of the device to visual feedback such as augmented reality or in the future, ocular implants and peripheral-central nervous system connection using advancing technologies like Neuralink. This method can also provide a new paradigm for observing teaching methods during education and the methods used to evaluate the students for plagiarism and cheating during tests that eliminate human bias and favoritism (human fallacy) during difficult times like that of the coronavirus quarantining.

Additional Discussion: The sensation of touch is an integral part of using one's hands. It's the way one feels the world around them, controls their grip force, manipulates objects with dexterity, and reacts to the environment. The way it works is with sensors in the glabrous skin of the hands called mechanoreceptors that are broken up into 2 broad categories: rapidly adapting (RA) and slowly adapting (SA) [1-5]. These mechanoreceptors function similarly to the way red, green, and blue colors in a TV combine to make a full picture, transducing tactile experience into neural representations encoded in the electrochemical form of action potential pulses [6].

Researchers around the world have spent decades observing these action potential responses to mechanical stimulation for a variety of tactile interactions; force [7], vibration [8-10], roughness [11], temperature [12], indentation [13], tangential torque [14], softness [15], sliding speed [16]. They even look at the densities [2] and spatial properties [3] of these mechanoreceptors in the skin as this plays a role in information transduction.

Combining the knowledge from this research has provided models to reproduce these firing patterns through artificial tactile sensors. Researchers explore modeling a variety of biomimetic firing patterns, varying from the single neuron firing behavior of the Izhikevich neuron model [17] to biomimetic models for representing the aggregate firing of multiple mechanoreceptors [18]. Spiking neural networks have also been used [19]. These types of models have been applied to sensory feedback in the invasive restoration for patients with upper limb amputations using peripheral neural interfaces [20-28]. Applications include position feedback [21], the restoration of grip force and motor coordination [22, 28], object [23], and texture [29] discrimination, as well as overall task performance [25].

Sankar et al. combined a soft biomimetic finger with a sensor array for generating slowly adapting (SA-1) spiking patterns to discriminate among 13 different textures. They used neuromorphic encoding (Izhikevich neuron model and tonic spiking model) to convert the sensor response into a neural spiking pattern. A support vector machine (SVM) in MATLAB classified the predicted texture based on spiking features, average ITI and mean spiking rate with an average overall texture classification accuracy of 99.57%. This was tested on three able-bodied subjects using transcutaneous electrical nerve stimulation (TENS), and the subjects successfully distinguished two or three textures with the applied stimuli. [30]

In addition to the encoding methods to provide sensory feedback, there have been several approaches to decode neural activity into meaningful action [26, 31, 32]. To access the information, there needs to be a neural interface to read the signals from the body. Some approaches include regenerative peripheral neural interfaces (RPNI) [26, 33-35] and targeted muscle reinnervation (TMR) to rewire a severed nerve into a new piece of muscle. This provides a high density of EMG measurements for direct multi-finger control.

While these interfaces are great for decoding motor actions, they can also be used for decoding sensory stimuli. These researchers [36] demonstrated that instantaneous force and torque at the fingerpad could be decoded in real-time, requiring no a priori knowledge of the stimulus. They recruited 58 SA-I and 25 RA-1 and used sliding window binning to train and test a 15-fold cross-validation.

These incredible research paradigms of closed-loop neuroprostheses aim to restore the sensorimotor interplay [27, 37], but there are still many hurdles to overcome in the restoration of naturally perceived sensation.

Graczyk et. Al documented the effects of varying pulse frequency on the quality of perceived sensations through neural stimulations. This study was conducted with 6 male volunteers (Four participants had unilateral acquired amputations of the upper limb below the elbow and two had unilateral acquired amputations of the lower limb below the knee). They each were implanted with 8-channel FINEs or 16-channel C-FINEs around the median, ulnar, and/or radial nerves between 3 and 7 years prior to participation in the study. They reported that, “increases in PF lead to systematic increases in perceived frequency, up to about 50 Hz, at which point further changes in PF have little to no impact on sensory quality” and “at higher PFs, perceived frequency remained constant or even decreased with increases in PF and was instead modulated by PW.” “In summary, the participants exhibited a slight tendency to select the more intense stimulus as being lower in frequency, consistent with previous findings that the pitch of a vibrotactile stimulus decreases as the stimulus amplitude increases over this range of frequencies (Roy and Hollins, 1998; Prsa et al., 2021)” [38].

Reference [39] showed that spike timing matters in the perceptions of frequency. The authors of [39] demonstrated a variety of stimuli bursting and period permutations, systematically increasing the number of spikes/burst and number of bursts/second.

Another group implanted a USEA for sensory stimulation [18]. They evaluated encoding methods for converting the tactile force and the rate of change of force into binary, linear, and 2 biomimetic patterns for firing rates. The results showed that the biomimetic encoding methods consistently outperformed the binary and linear in all scenarios for size and compliance with a p<0.05. [18]

Reference [40] discusses the importance of the first spike in ensembles of tactile afferents during natural object manipulation rather than just the frequency for the fine encoding as they discuss the information about tactile interaction being faster than can be readily explained through rate codes.

Another factor in perception and the sensorimotor integration is proprioception, which is composed of the sensory signals containing information of the position of limbs. Combining this positional awareness with the sensation from the skin the body can efficiently react to the environment.

In perception theory there are two main concepts: direct and constructional perception [41]. Direct perception refers to information completely residing in the external environment. Constructional says that part of the information is in the external environment and part of it is constructed internally to produce the total perception. Is experience a combination of these theories from both the structure and the function of one's body and brain? These are analogous to the way a computer is a structure that functions to produce the pictures seen on a computer screen. When a peripheral is plugged into a computer there is an interface that translates the information from one side to the other. In one's body this is done through a synapse that connects one neuron to another.

In the lab, researchers have gained insight into these interactions between artificial systems and biological ones using a variety of devices called multielectrode arrays (MEAs) [42-48]. They have documented the growth of cultures and the formations of the spontaneous firing behaviors they exhibit over multiple days in-vitro [49]. Recording can be made in a variety of manners; intracellular recordings use patch clamps to directly measure the membrane potential at the location of connection, gathering single-unit action potentials (SUAPs), while extracellular recordings measure the electrical potential for a region surrounding the electrode, gathering multi-unit action potentials (MUAPs).

In MEAs, these extracellular recordings have been analyzed for action potential landscape to show the waveform shapes at different spatial locations from the soma [47]. Groups have evaluated stimulation parameters [50, 51] which have allowed them to interact with these EBCs for directly observing evoked activity [52] while implementing artifact suppression to remove unwanted information due to the stimulus [53].

In 2004, Bakkum et. Al closed the loop on a multielectrode array setup, manipulating the motor output of a hybrid living and robotic system they called the “Hybrot”. First, they control a simulated animal in a virtual environment. They used electrically-evoked signals to manipulate the ITIs of the recorded firing and mapped the output to a control signal of moving in different modes. They demonstrated the output on the “Hybrot” as well as another setup using markers to draw on a piece of paper [43].

In 2006 Potter et. al., expanded the knowledge of the previous work on the “Hybrot”. They discussed techniques for long-term culturing as well as other methods for improving the results of the experiments in MEAs [45].

These researchers set a desired motor output vector direction to train a closed loop network. They have a recording section for measuring a “probe” electrode and transforming the measurement into a direction vector to compare to the desired motor output. This determines the type of stimulation for the next iteration in the loop. They use a fixed stimulation waveform (biphasic, ±300 mV, 200 ms<I<400 ms) to stimulate three different types of electrical stimulation: Context-probing sequence (CPS), patterned training stimuli (PTS) and shuffled background stimulation (SBS). The flow of the controller stimulated with one type of pattern for correct movements and a different pattern for the incorrect movements, excitatorily and inhibitorily, respectively. To make a decision the culture was probed every 6 s and recorded for 100 ms to obtain the center of activity vector [42].

Even with the state-of-the-art technology, training the individual remains a topic of research as every individual has a unique perception to a variety of biomimetic stimuli. Some techniques include mirroring the residing limb to improve motor control [54].

Example Computing Device. Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing systems (e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more example embodiments, the functions described may be implemented in hardware, software, firmware, or any combination thereof. If implemented in software, the functions may be stored as one or more instructions or codes on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc, where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

### REFERENCES

[1] R. S. Johansson, “Tactile sensibility in the human hand: receptive field characteristics of mechanoreceptive units in the glabrous skin area,” The Journal of physiology, vol. 281, no. 1, pp. 101-125, 1978.
[2] R. S. Johansson and A. Vallbo, “Tactile sensibility in the human hand: relative and absolute densities of four types of mechanoreceptive units in glabrous skin,” The Journal of physiology, vol. 286, no. 1, pp. 283-300, 1979.
[3] R. S. Johansson and Å. B. Vallbo, “Spatial properties of the population of mechanoreceptive units in the glabrous skin of the human hand,” Brain Research, vol. 184, no. 2, pp. 353-366, 1980 Feb. 24/ 1980, doi: https://doi.org/10.1016/0006-8993(80)90804-5.
[4] E. A. Lumpkin, K. L. Marshall, and A. M. Nelson, “The cell biology of touch,” The Journal of Cell Biology, vol. 191, no. 2, pp. 237-248, 2010, doi: 10.1083/jcb.201006074.
[5] F. McGlone, J. Wessberg, and H. Olausson, “Discriminative and Affective Touch: Sensing and Feeling,” Neuron, vol. 82, no. 4, pp. 737-755, 2014 May 21/ 2014, doi: https://doi.org/10.1016/j.neuron.2014.05.001.
[6] P. Delmas, J. Hao, and L. Rodat-Despoix, “Molecular mechanisms of mechanotransduction in mammalian sensory neurons,” Nature Reviews Neuroscience, Review Article vol. 12, p. 139, 02/09/online 2011, doi: 10.1038/nrn2993.
[7] I. Birznieks, V. G. Macefield, G. Westling, and R. S. Johansson, “Slowly Adapting Mechanoreceptors in the Borders of the Human Fingernail Encode Fingertip Forces,” The Journal of Neuroscience, vol. 29, no. 29, p. 9370, 2009, doi: 10.1523/JNEUROSCL.0143-09.2009.
[8] P. Slavik and J. Bell, “A mechanoreceptor model for rapidly and slowly adapting afferents subjected to periodic vibratory stimuli,” Mathematical Biosciences, vol. 130, no. 1, pp. 1-23, 1995 Nov. 1/ 1995, doi: https://doi.org/10.1016/0025-5564(94)00083-C.
[9] A. W. Freeman and K. O. Johnson, “Cutaneous mechanoreceptors in macaque monkey: temporal discharge patterns evoked by vibration, and a receptor model,” The Journal of physiology, vol. 323, no. 1, pp. 21-41, 1982.
[10] A. W. Freeman and K. O. Johnson, “A model accounting for effects of vibratory amplitude on responses of cutaneous mechanoreceptors in macaque monkey,” The Journal of physiology, vol. 323, no. 1, pp. 43-64, 1982.
[11] C. E. Connor and K. O. Johnson, “Neural coding of tactile texture: comparison of spatial and temporal mechanisms for roughness perception,” The Journal of Neuroscience, vol. 12, no. 9, p. 3414, 1992, doi: 10.1523/JNEUROSCI.12-09-03414.1992.
[12] K. Zimmermann et al., “Phenotyping sensory nerve endings in vitro in the mouse,” (in eng), Nat Protoc, vol. 4, no. 2, pp. 174-196, 2009, doi: 10.1038/nprot.2008.223.
[13] A. P. Sripati, S. J. Bensmaia, and K. O. Johnson, “A Continuum Mechanical Model of Mechanoreceptive Afferent Responses to Indented Spatial Patterns,” Journal of Neurophysiology, vol. 95, no. 6, pp. 3852-3864, 2006, doi: 10.1152/jn.01240.2005.
[14] I. Birznieks, H. E. Wheat, S. J. Redmond, L. M. Salo, N. H. Lovell, and A. W. Goodwin, “Encoding of tangential torque in responses of tactile afferent fibres innervating the fingerpad of the monkey,” The Journal of physiology, vol. 588, no. 7, pp. 1057-1072, 2010.
[15] J. Hu, Q. Zhao, R. Jiang, R. Wang, and X. Ding, “Responses of cutaneous mechanoreceptors within fingerpad to stimulus information for tactile softness sensation of materials,” Cognitive neurodynamics, vol. 7, no. 5, pp. 441-447, 2013.
[16] A. Dépeault, E.-M. Meftah, and C. E. Chapman, “Tactile speed scaling: contributions of time and space,” J. Neurophysiol., vol. 99, no. 3, pp. 1422-1434, 2008.
[17] E. M. Izhikevich, “Simple model of spiking neurons,” IEEE Transactions on neural networks, vol. 14, no. 6, pp. 1569-1572, 2003.
[18] J. A. George et al., “Biomimetic sensory feedback through peripheral nerve stimulation improves dexterous use of a bionic hand,” Science Robotics, vol. 4, no. 32, p. eaax2352, 2019.
[19] A. Parvizi-Fard, M. Amiri, D. Kumar, M. M. Iskarous, and N. V. Thakor, “A functional spiking neuronal network for tactile sensing pathway to process edge orientation,” Scientific Reports, vol. 11, no. 1, p. 1320, 2021/01/14 2021, doi: 10.1038/s41598-020-80132-4.
[20] G. A. Clark et al., “Using multiple high-count electrode arrays in human median and ulnar nerves to restore sensorimotor function after previous transradial amputation of the hand,” in 2014 36^{th} Annual International Conference of the IEEE Engineering in Medicine and Biology Society, 26-30 Aug. 2014 2014, pp. 1977-1980, doi: 10.1 109/EMBC.2014.6944001.
[21] E. D'Anna et al., “A closed-loop hand prosthesis with simultaneous intraneural tactile and position feedback,” Science Robotics, vol. 4, no. 27, p. eaau8892, 2019.
[22] F. Clemente et al., “Intraneural sensory feedback restores grip force control and motor coordination while using a prosthetic hand,” Journal of neural engineering, vol. 16, no. 2, p. 026034, 2019.
[23] K. Horch, S. Meek, T. G. Taylor, and D. T. Hutchinson, “Object Discrimination With an Artificial Hand Using Electrical Stimulation of Peripheral Tactile and Proprioceptive Pathways With Intrafascicular Electrodes,” IEEE Transactions on Neural Systems and Rehabilitation Engineering, vol. 19, no. 5, pp. 483-489, 2011, doi: 10.1109/TNSRE.2011.2162635.
[24] H. P. Saal and S. J. Bensmaia, “Biomimetic approaches to bionic touch through a peripheral nerve interface,” Neuropsychologia, vol. 79, pp. 344-353, 2015.
[25] M. Schiefer, D. Tan, S. M. Sidek, and D. J. Tyler, “Sensory feedback by peripheral nerve stimulation improves task performance in individuals with upper limb loss using a myoelectric prosthesis,” Journal of neural engineering, vol. 13, no. 1, p. 016001, 2015.
[26] C. M. Frost et al., “Regenerative peripheral nerve interfaces for real-time, proportional control of a Neuroprosthetic hand,” Journal of neuroengineering and rehabilitation, vol. 15, no. 1, pp. 1-9, 2018.
[27] D. Farina et al., “Toward higher-performance bionic limbs for wider clinical use,” Nature Biomedical Engineering, 2021 May 31 2021, doi: 10.1038/s41551-021-00732-x.
[28] G. S. Dhillon and K. W. Horch, “Direct neural sensory feedback and control of a prosthetic arm,” IEEE transactions on neural systems and rehabilitation engineering, vol. 13, no. 4, pp. 468-472, 2005.
[29] C. M. Oddo et al., “Intraneural stimulation elicits discrimination of textural features by artificial fingertip in intact and amputee humans,” eLife, vol. 5, p. e09148, 2016 Mar. 8 2016, doi: 10.7554/eLife.09148.
[30] S. Sankar et al., “Texture Discrimination with a Soft Biomimetic Finger Using a Flexible Neuromorphic Tactile Sensor Array That Provides Sensory Feedback,” Soft Robotics, 2020.
[31] S. Micera et al., “Decoding Information From Neural Signals Recorded Using Intraneural Electrodes: Toward the Development of a Neurocontrolled Hand Prosthesis,” Proceedings of the IEEE, vol. 98, no. 3, pp. 407-417, 2010, doi: 10.1109/JPROC.2009.2038726.
[32] R. Quian Quiroga and S. Panzeri, “Extracting information from neuronal populations: information theory and decoding approaches,” Nat Rev Neurosci, vol. 10, no. 3, pp. 173-85, March 2009, doi: 10.1038/nrn2578.
[33] Z. Irwin et al., “Chronic recording of hand prosthesis control signals via a regenerative peripheral nerve interface in a rhesus macaque,” Journal of neural engineering, vol. 13, no. 4, p. 046007, 2016.
[34] P. P. Vu et al., “A regenerative peripheral nerve interface allows real-time control of an artificial hand in upper limb amputees,” (in eng), Science translational medicine, vol. 12, no. 533, p. eaay2857, 2020, doi: 10.1126/scitranslmed.aay2857.
[35] P. P. Vu et al., “Closed-Loop Continuous Hand Control via Chronic Recording of Regenerative Peripheral Nerve Interfaces,” IEEE Transactions on Neural Systems and Rehabilitation Engineering, vol. 26, no. 2, pp. 515-526, 2018, doi: 10.1109/TNSRE.2017.2772961.
[36] H. Khamis, I. Birznieks, and S. J. Redmond, “Decoding tactile afferent activity to obtain an estimate of instantaneous force and torque applied to the fingerpad,” (in English), Journal of Neurophysiology, Article vol. 114, no. 1, pp. 474-484, July 2015, doi: 10.1152/jn.00040.2015.
[37] L. Zollo et al., “Restoring tactile sensations via neural interfaces for real-time force-and-slippage closed-loop control of bionic hands,” Science Robotics, vol. 4, no. 27, p. eaau9924, 2019.
[38] E. L. Graczyk, B. P. Christie, Q. He, D. J. Tyler, and S. J. Bensmaia, “Frequency shapes the quality of tactile percepts evoked through electrical stimulation of the nerves,” Journal of Neuroscience, 2022.
[39] I. Birznieks and R. M. Vickery, “Spike timing matters in novel neuronal code involved in vibrotactile frequency perception,” Current Biology, vol. 27, no. 10, pp. 1485-1490. E2, 2017.
[40] R. S. Johansson and I. Birznieks, “First spikes in ensembles of human tactile afferents code complex spatial fingertip events,” Nature neuroscience, vol. 7, no. 2, pp. 170-177, 2004.
[41] K. H. Pribram, Brain and perception: Holonomy and structure in figural processing. Psychology Press, 2013.
[42] D. J. Bakkum, Z. C. Chao, and S. M. Potter, “Spatio-temporal electrical stimuli shape behavior of an embodied cortical network in a goal-directed learning task,” Journal of neural engineering, vol. 5, no. 3, p. 310, 2008.
[43] D. J. Bakkum, A. C. Shkolnik, G. Ben-Ary, P. Gamblen, T. B. DeMarse, and S. M. Potter, “Removing some ‘A’ from AI: Embodied cultured networks,” in Embodied artificial intelligence: Springer, 2004, pp. 130-145.
[44] F. Franke et al., “High-density microelectrode array recordings and real-time spike sorting for closed-loop experiments: an emerging technology to study neural plasticity,” (in English), Frontiers in Neural Circuits, Mini Review vol. 6, no. 105, 2012—Dec. 20, 2012, doi: 10.3389/fncir.2012.00105.
[45] S. M. Potter, D. A. Wagenaar, and T. B. DeMarse, “Closing the loop: stimulation feedback systems for embodied MEA cultures,” in Advances in network electrophysiology: Springer, 2006, pp. 215-242.
[46] L. Xu et al., “Trends and recent development of the microelectrode arrays (MEAs),” Biosensors and Bioelectronics, vol. 175, p. 112854, 2021.
[47] D. J. Bakkum et al., “The Axon Initial Segment is the Dominant Contributor to the Neuron's Extracellular Electrical Potential Landscape,” Advanced Biosystems, vol. 3, no. 2, p. 1800308, 2019, doi: 10.1002/adbi.201800308.
[48] M. E. J. Obien, K. Deligkaris, T. Bullmann, D. J. Bakkum, and U. Frey, “Revealing neuronal function through microelectrode array recordings,” (in English), Frontiers in Neuroscience, Review vol. 8, no. 423, 2015—Jan. 6, 2015, doi: 10.3389/fnins.2014.00423.
[49] D. A. Wagenaar, J. Pine, and S. M. Potter, “An extremely rich repertoire of bursting patterns during the development of cortical cultures,” BMC neuroscience, vol. 7, no. 1, pp. 1-18, 2006.
[50] D. A. Wagenaar, J. Pine, and S. M. Potter, “Effective parameters for stimulation of dissociated cultures using multi-electrode arrays,” Journal of neuroscience methods, vol. 138, no. 1-2, pp. 27-37, 2004.
[51] C. Gunter, J. Delbeke, and M. Ortiz-Catalan, “Safety of long-term electrical peripheral nerve stimulation: review of the state of the art,” Journal of neuroengineering and rehabilitation, vol. 16, no. 1, p. 13, 2019.
[52] D. A. Wagenaar and S. M. Potter, “A versatile all-channel stimulator for electrode arrays, with real-time control,” Journal of neural engineering, vol. 1, no. 1, p. 39, 2004.
[53] D. A. Wagenaar and S. M. Potter, “Real-time multi-channel stimulus artifact suppression by local curve fitting,” Journal of Neuroscience Methods, vol. 120, no. 2, pp. 113-120, 2002 Oct. 30/ 2002, doi: https://doi.org/10.1016/S0165-0270(02)00149-8.
[54] J. A. George, T. N. Tully, P. C. Colgan, and G. A. Clark, “Bilaterally mirrored movements improve the accuracy and precision of training data for supervised learning of neural or myoelectric prosthetic control,” in 2020 42^{nd} Annual International Conference of the IEEE Engineering in Medicine & Biology Society (EMBC), 2020: IEEE, pp. 3297-3301.
[55] C. Ades, M. A. Abd, E. Du, J. Wei, E. Tognoli, and E. D. Engeberg, “Robotically Embodied Biological Neural Networks to Investigate Haptic Restoration with Neuroprosthetic Hands,” in 2022 IEEE Haptics Symposium (HAPTICS), 2022: IEEE, pp. 1-7.
[56] M. A. Abd et al., “Impacts of soft robotic actuator geometry on end effector force and displacement,” in 30^{th} Florida Conference on Recent Advances in Robotics, May, 2017, pp. 11-12.
[57] C. Ades et al., “Robotic Finger Force Sensor Fabrication and Evaluation Through a Glove,” in Proceedings. Florida Conference on Recent Advances in Robotics, 2018, vol. 2018, pp. 60-65.
[58] C. J. Ades, S. Dilibal, and E. D. Engeberg, “Shape memory alloy tube actuators inherently enable internal fluidic cooling for a robotic finger under force control,” Smart Materials and Structures, vol. 29, no. 11, p. 115009, 2020.
[59] J. Ingicco, M. AlSaidi, M. Abd, C. Ades, and E. Engeberg, “Force and Pressure Control of Soft Robotic Actuators,” in Proceedings. Florida Conference on Recent Advances in Robotics, 2018, vol. 2018: NIH Public Access, p. 39.
[60] Y. Bar-Cohen, High temperature materials and mechanisms. CRC Press Boca Raton, FL, USA: 2014.
[61] K. Otsuka and C. M. Wayman, Shape memory materials. Cambridge university press, 1999.
[62] H. T. Lee, M. S. Kim, G. Y. Lee, C. S. Kim, and S. H. Ahn, “Shape memory alloy (sma)-based microscale actuators with 60% deformation rate and 1.6 kHz actuation speed,” Small, vol. 14, no. 23, p. 1801023, 2018.
[63] M. Sreekumar, T. Nagarajan, M. Singaperumal, M. Zoppi, and R. Molfino, “Critical review of current trends in shape memory alloy actuators for intelligent robots,” Industrial Robot: An International Journal, 2007.
[64] A. Nespoli, S. Besseghini, S. Pittaccio, E. Villa, and S. Viscuso, “The high potential of shape memory alloys in developing miniature mechanical devices: A review on shape memory alloy mini-actuators,” Sensors and Actuators A: Physical, vol. 158, no. 1, pp. 149-160, 2010.
[65] J. M. Jani, M. Leary, A. Subic, and M. A. Gibson, “A review of shape memory alloy research, applications and opportunities,” Materials & Design (1980-2015), vol. 56, pp. 1078-1113, 2014.
[66] Y. H. I and R. Featherstone, “An architecture for fast and accurate control of shape memory alloy actuators,” The International Journal of Robotics Research, vol. 27, no. 5, pp. 595-611, 2008.
[67] A. B. Hegana, S. Hariharan, and E. D. Engeberg, “Electromechanical conversion of low-temperature waste heat via helical shape memory alloy actuators,” IEEE/ASME Transactions on Mechatronics, vol. 21, no. 3, pp. 1434-1444, 2015.
[68] S. Yan, X. Liu, F. Xu, and J. Wang, “A gripper actuated by a pair of differential SMA springs,” Journal of Intelligent Material Systems and Structures, vol. 18, no. 5, pp. 459-466, 2007.
[69] E. D. Engeberg, S. Dilibal, M. Vatani, J.-W. Choi, and J. Lavery, “Anthropomorphic finger antagonistically actuated by SMA plates,” Bioinspiration & biomimetics, vol. 10, no. 5, p. 056002, 2015.
[70] T. Mineta, S. Kudoh, E. Makino, T. Kawashima, and T. Shibata, “Accurate and simple assembly process of shape memory alloy tubular micro manipulator with a bias mechanism,” Microelectronic engineering, vol. 88, no. 8, pp. 2683-2686, 2011.
[71] Y. I. Yoo, J. W. Jeong, J. J. Lee, and C. H. Lee, “Effect of heat treatment on the two-way recovery stress of tube-shaped NiTi,” Journal of intelligent material systems and structures, vol. 23, no. 10, pp. 1161-1168, 2012.
[72] Y. L Yoo, J. J. Lee, C. H. Lee, and J. H. Lim, “An experimental study of the two-way shape memory effect in a NiTi tubular actuator,” Smart materials and structures, vol. 19, no. 12, p. 125002, 2010.
[73] R. Aversa et al., “Biomechanically inspired shape memory effect machines driven by muscle like acting NiTi alloys,” American Journal of Applied Sciences, vol. 13, no. 11, pp. 1264-1271, 2016.
[74] K. Andrianesis and A. Tzes, “Development and control of a multifunctional prosthetic hand with shape memory alloy actuators,” Journal of Intelligent & Robotic Systems, vol. 78, no. 2, pp. 257-289, 2015.
[75] D. Copaci, E. Cano, L. Moreno, and D. Blanco, “New design of a soft robotics wearable elbow exoskeleton based on shape memory alloy wire actuators,” Applied Bionics and Biomechanics, vol. 2017, 2017.
[76] K. J. D. Laurentis and C. Mavroidis, “Mechanical design of a shape memory alloy actuated prosthetic hand,” Technology and Health Care, vol. 10, no. 2, pp. 91-106, 2002.
[77] K.-J. Cho and H. H. Asada, “Architecture design of a multiaxis cellular actuator array using segmented binary control of shape memory alloy,” IEEE transactions on robotics, vol. 22, no. 4, pp. 831-843, 2006.
[78] A. Price, A. Jnifene, and H. Naguib, “Design and control of a shape memory alloy based dexterous robot hand,” Smart Materials and Structures, vol. 16, no. 4, p. 1401, 2007.
[79] J. B. Rosmarin and H. H. Asada, “Synergistic design of a humanoid hand with hybrid dc motor-sma array actuators embedded in the palm,” in 2008 IEEE International Conference on Robotics and Automation, 2008: IEEE, pp. 773-778.
[80] V. Bundhoo, E. Haslam, B. Birch, and E. J. Park, “A shape memory alloy-based tendon-driven actuation system for biomimetic artificial fingers, part I: design and evaluation,” Robotica, vol. 27, no. 1, pp. 131-146, 2009.
[81] A. F. C. Silva, A. J. V. dos Santos, C. d. R. Souto, C. J. de Aradjo, and S. A. da Silva, “Artificial Biometric Finger Driven by Shape-Memory Alloy Wires,” Artificial Organs, vol. 37, no. 11, pp. 965-972, 2013.
[82] P. L. Bishay and A. R. Sofi, “Sensitivity analysis of a smart soft composite robotic finger design using geometrically nonlinear laminated composite finite beam elements,” Materials Today Communications, vol. 16, pp. 111-118, 2018.
[83] F. Gao, H. Deng, and Y. Zhang, “Hybrid actuator combining shape memory alloy with DC motor for prosthetic fingers,” Sensors and Actuators A: Physical, vol. 223, pp. 40-48, 2015.
[84] F. Simone, A. York, and S. Seelecke, “Design and fabrication of a three-finger prosthetic hand using SMA muscle wires,” in Bioinspiration, Biomimetics, and Bioreplication 2015, 2015, vol. 9429: SPIE, pp. 128-135.
[85] E. D. Engeberg and S. G. Meek, “Adaptive sliding mode control for prosthetic hands to simultaneously prevent slip and minimize deformation of grasped objects,” IEEE/ASME Transactions on Mechatronics, vol. 18, no. 1, pp. 376-385, 2011.
[86] J. C. Becker and N. V. Thakor, “A study of the range of motion of human fingers with application to anthropomorphic designs,” IEEE Transactions on Biomedical Engineering, vol. 35, no. 2, pp. 110-117, 1988.
[87] M. Bergamasco, F. Salsedo, and P. Dario, “Shape memory alloy micromotors for direct-drive actuation of dexterous artificial hands,” Sensors and Actuators, vol. 17, no. 1-2, pp. 115-119, 1989.
[88] H. Rodrigue, W. Wang, D.-R. Kim, and S.-H. Ahn, “Curved shape memory alloy-based soft actuators and application to soft gripper,” Composite Structures, vol. 176, pp. 398-406, 2017.
[89] C. Ades, S. Dilibal, and E. Engeberg, “Exoskeleton for tubular shape memory alloy finger with internal cooling and a superelastic SMA spring return,” in ASME Florida Conference on Recent Advances in Robotics, Miami, Florida, 2016.
[90] Y. Tenzer, L. P. Jentoft, and R. D. Howe, “The feel of MEMS barometers: Inexpensive and easily customized tactile array sensors,” IEEE Robotics & Automation Magazine, vol. 21, no. 3, pp. 89-95, 2014.
[91] E. D. Engeberg and S. Dilibal, “Antagonistically actuated shape memory alloy manipulator,” ed: Google Patents, 2017.
[92] D. Yoon and Y. Choi, “Underactuated finger mechanism using contractible slider-cranks and stackable four-bar linkages,” IEEE/ASME Transactions on Mechatronics, vol. 22, no. 5, pp. 2046-2057, 2017.
[93] J. T. Belter, J. L. Segil, and B. SM, “Mechanical design and performance specifications of anthropomorphic prosthetic hands: a review,” Journal of rehabilitation research and development, vol. 50, no. 5, p. 599, 2013.
[94] J.-J. E. Slotine and W. Li, Applied nonlinear control (no. 1). Prentice hall Englewood Cliffs, NJ, 1991.
[95] N. M. N. Adnan, M. N. A. Ab Patar, H. Lee, S.-I. Yamamoto, L. Jong-Young, and J. Mahmud, “Biomechanical analysis using Kinovea for sports application,” in IOP conference series: materials science and engineering, 2018, vol. 342, no. 1: IOP Publishing, p. 012097.
[96] M. Abdeetedal and M. R. Kermani, “Grasp and stress analysis of an underactuated finger for proprioceptive tactile sensing,” IEEE/ASME Transactions on Mechatronics, vol. 23, no. 4, pp. 1619-1629, 2018.
[97] M. Faulkner, J. Amalraj, and A. Bhattacharyya, “Experimental determination of thermal and electrical properties of Ni—Ti shape memory wires,” Smart Materials and Structures, vol. 9, no. 5, p. 632, 2000.
[98] S. Degeratu, P. Rotaru, G. Manolea, H. Manolea, and A. Rotaru, “Thermal characteristics of Ni—Ti SMA (shape memory alloy) actuators,” Journal of thermal analysis and calorimetry, vol. 97, no. 2, pp. 695-700, 2009.
[99] S. S. Cheng, Y. Kim, and J. P. Desai, “New actuation mechanism for actively cooled SMA springs in a neurosurgical robot,” IEEE Transactions on Robotics, vol. 33, no. 4, pp. 986-993, 2017.
[100] X. Tang et al., “Temperature self-sensing and closed-loop position control of twisted and coiled actuator,” Sensors and Actuators A: Physical, vol. 285, pp. 319-328, 2019.
[101] A. M. Nizamani, J. Daudpoto, and M. A. Nizamani, “Development of faster SMA actuators,” Shape memory alloys—fundamentals and applications, pp. 106-126, 2017.
[102] R. N. Saunders, J. G. Boyd, D. J. Harti, F. T. Calkins, and D. C. Lagoudas, “A simplified model for high-rate actuation of shape memory alloy torque tubes using induction heating,” Journal of Intelligent Material Systems and Structures, vol. 29, no. 6, pp. 1088-1101, 2018.
[103] Y. Tadesse, N. Thayer, and S. Priya, “Tailoring the response time of shape memory alloy wires through active cooling and pre-stress,” Journal of Intelligent Material Systems and Structures, vol. 21, no. 1, pp. 19-40, 2010.
[104] B. Utter, “Enhancing the actuation frequency of shape memory alloy wire by vibration-enhanced cooling,” Journal of Intelligent Material Systems and Structures, vol. 30, no. 20, pp. 3177-3189, 2019.
[105] J. Owusu-Danquah, A. Saleeb, B. Dhakal, and S. Padula, “A comparative study of Ni49.9Ti50.1 and Ni50.3Ti29.7Hf20 tube actuators,” Journal of Materials Engineering and Performance, vol. 24, no. 4, pp. 1726-1740, 2015.
[106] S. Qian, J. Ling, Y. Hwang, I. Takeuchi, and R. Radermacher, “Modeling and optimization of a novel heat recovery design for thermoelastic cooling systems,” in ASME International Mechanical Engineering Congress and Exposition, 2015, vol. 57441: American Society of Mechanical Engineers, p. V06BT07A009.
[107] H. Badnava, M. Kadkhodaei, and M. Mashayekhi, “Modeling of unstable behaviors of shape memory alloys during localization and propagation of phase transformation using a gradient-enhanced model,” Journal of Intelligent Material Systems and Structures, vol. 26, no. 18, pp. 2531-2546, 2015.
[108] N. J. Bechle and S. Kyriakides, “Evolution of phase transformation fronts and associated thermal effects in a NiTi tube under a biaxial stress state,” Extreme Mechanics Letters, vol. 8, pp. 55-63, 2016.
[109] Y. Xiao, P. Zeng, and L. Lei, “Micromechanical modeling on thermomechanical coupling of cyclically deformed superelastic NiTi shape memory alloy,” International Journal of Plasticity, vol. 107, pp. 164-188, 2018.
[110] D. Jiang, S. Kyriakides, N. J. Bechle, and C. M. Landis, “Bending of pseudoelastic NiTi tubes,” International Journal of Solids and Structures, vol. 124, pp. 192-214, 2017.
[111] D. Jiang, S. Kyriakides, C. M. Landis, and K. Kazinakis, “Modeling of propagation of phase transformation fronts in NiTi under uniaxial tension,” European Journal of Mechanics—A/Solids, vol. 64, pp. 131-142, 2017.
[112] K. Ziegler-Graham, E. J. MacKenzie, P. L. Ephraim, T. G. Travison, and R. Brookmeyer, “Estimating the prevalence of limb loss in the United States: 2005 to 2050,” Archives of physical medicine and rehabilitation, vol. 89, no. 3, pp. 422-429, 2008.
[113] R. S. Dahiya, G. Metta, M. Valle, and G. Sandini, “Tactile sensing—from humans to humanoids,” IEEE transactions on robotics, vol. 26, no. 1, pp. 1-20, 2009.
[114] M. A. Abd, J. Ingicco, D. T. Hutchinson, E. Tognoli, and E. D. Engeberg, “Multichannel haptic feedback unlocks prosthetic hand dexterity,” Scientific reports, vol. 12, no. 1, pp. 1-17, 2022.
[115] M. A. Abd et al., “Hierarchical tactile sensation integration from prosthetic fingertips enables multi-texture surface recognition,” Sensors, vol. 21, no. 13, p. 4324, 2021.
[116] D. A. Wagenaar, R. Madhavan, J. Pine, and S. M. Potter, “Controlling bursting in cortical cultures with closed-loop multi-electrode stimulation,” Journal of Neuroscience, vol. 25, no. 3, pp. 680-688, 2005.
[117] T. B. DeMarse, D. A. Wagenaar, A. W. Blau, and S. M. Potter, “The neurally controlled animat: biological brains acting with simulated bodies,” Autonomous robots, vol. 11, no. 3, pp. 305-310, 2001.
[118] B. J. Kagan et al., “In vitro neurons learn and exhibit sentience when embodied in a simulated game-world,” bioRxiv, 2021.
[119] A. Novellino, P. D'Angelo, L. Cozzi, M. Chiappalone, V. Sanguineti, and S. Martinoia, “Connecting neurons to a mobile robot: an in vitro bidirectional neural interface,” Computational Intelligence and Neuroscience, vol. 2007, 2007.
[120] J. Tessadori, M. Bisio, S. Martinoia, and M. Chiappalone, “Modular neuronal assemblies embodied in a closed-loop environment: toward future integration of brains and machines,” Frontiers in neural circuits, vol. 6, p. 99, 2012.
[121] C. Gunter, J. Delbeke, and M. Ortiz-Catalan, “Safety of long-term electrical peripheral nerve stimulation: review of the state of the art,” Journal of neuroengineering and rehabilitation, vol. 16, no. 1, pp. 1-16, 2019.
[122] S. Shchanikov et al., “Designing a bidirectional, adaptive neural interface incorporating machine learning capabilities and memristor-enhanced hardware,” Chaos, solitons & fractals, vol. 142, p. 110504, 2021.
[123] K.-C. Nguyen and V. Perdereau, “Fingertip force control based on max torque adjustment for dexterous manipulation of an anthropomorphic hand,” in 2013 IEEE/RSJ international conference on intelligent robots and systems, 2013: IEEE, pp. 3557-3563.
[124] X. Li, X. Yao, J. Fox, and J. G. Jefferys, “Interaction dynamics of neuronal oscillations analysed using wavelet transforms,” J Neurosci Methods, vol. 160, no. 1, pp. 178-85, Feb. 15, 2007, doi: 10.1016/j.jneumeth.2006.08.006.
[125] D. Lee, “Coherent oscillations in neuronal activity of the supplementary motor area during a visuomotor task,” Journal of Neuroscience, vol. 23, no. 17, pp. 6798-6809, 2003.
[126] S. Davarpanah Jazi and M. Heath, “Weber's law in tactile grasping and manual estimation: Feedback-dependent evidence for functionally distinct processing streams,” Brain and Cognition, vol. 86, pp. 32-41, 2014 Apr. 1/ 2014, doi: https://doi.org/10.1016/j.bandc.2014.01.014.
[127] C. Cipriani, J. L. Segil, F. Clemente, and B. Edin, “Humans can integrate feedback of discrete events in their sensorimotor control of a robotic hand,” Experimental brain research, vol. 232, no. 11, pp. 3421-3429, 2014.
[128] F. Clemente, M. D. Alonzo, M. Controzzi, B. B. Edin, and C. Cipriani, “Non-Invasive, Temporally Discrete Feedback of Object Contact and Release Improves Grasp Control of Closed-Loop Myoelectric Transradial Prostheses,” IEEE Transactions on Neural Systems and Rehabilitation Engineering, vol. 24, no. 12, pp. 1314-1322, 2016, doi: 10.1109/TNSRE.2015.2500586.
[129] L. F. Engels, A. W. Shehata, E. J. Scheme, J. W. Sensinger, and C. Cipriani, “When less is more-discrete tactile feedback dominates continuous audio biofeedback in the integrated percept while controlling a myoelectric prosthetic hand,” Frontiers in neuroscience, vol. 13, p. 578, 2019.
[130] B. Stephens-Fripp, G. Alici, and R. Mutlu, “A review of non-invasive sensory feedback methods for transradial prosthetic hands,” IEEE Access, vol. 6, pp. 6878-6899, 2018.
[131] C. Ly et al., “Psychedelics promote structural and functional neural plasticity,” Cell reports, vol. 23, no. 11, pp. 3170-3182, 2018.
[132] Moaed A. Abd, Joseph Ingicco, Douglas Hutchinson, Emmanuelle Tognoli, Erik D. Engeberg. “Multichannel Haptic Feedback Unlocks Prosthetic Hand Dexterity”. Accepted in Nature Scientific Report 2022.
[133] Moaed A. Abd., Rudy Paul, Aparna Aravelli, Ou Bai, Leonel Lagos, Maohua Lin, and Erik D. Engeberg. “Hierarchical Tactile Sensation Integration from Prosthetic Fingertips Enables Multi-Texture Surface Recognition.” Sensors 21, no. 13 (2021): 4324.
[134] Lin, Maohua, Moaed A. Abd, Alex 63aking, Chi-Tay Tsai, Frank D. Vrionis, and Erik D. Engeberg. “Robotic Replica of a Human Spine Uses Soft Magnetic Sensor Array to Forecast Intervertebral Loads and Posture after Surgery.” Sensors 22, no. 1 (2022): 212.
[135] Moaed A. Abd, Craig Ades, Sarah Du, Jianning Wei, Emmanuelle Tognoli, Erik D. Engeberg. Robotically Embodied Biological Neural Networks to Investigate Haptic Restoration with Neuroprosthetic Hands. Accepted in IEEE Haptics Symposium 2022.
[136] Olson, S., Abd, M. and Engeberg, E. D., 2021. Human-Inspired Robotic Eye-Hand Coordination Enables New Communication Channels Between Humans and Robots. International Journal of Social Robotics, 13(5), pp. 1033-1046.
[137] Abd, M. A., Gonzalez, I., Ades, C., Nojoumian, M. and Engeberg, E. D., 2019. Simulated robotic device malfunctions resembling malicious cyberattacks impact human perception of trust, satisfaction, and frustration. International Journal of Advanced Robotic Systems, 16(5), p. 1729881419874962.
[138] Abd, M. A., Al-Saidi, M., Lin, M., Liddle, G., Mondal, K. and Engeberg, E. D., 2020. Surface Feature Recognition and Grasped Object Slip Prevention with a Liquid Metal Tactile Sensor for a Prosthetic Hand. In 2020 8^{th} IEEE RAS/EMBS International Conference for Biomedical Robotics and Biomechatronics (BioRob) (pp. 1174-1179). IEEE.
[139] Abidalkareem, A. J., Abd, M. A., Ibrahim, A. K., Zhuang, H., Altaher, A. S. and Ali, A. M., 2020, July. Diabetic Retinopathy (DR) Severity Level Classification Using Multimodel Convolutional Neural Networks. In 2020 42^{nd} Annual International Conference of the IEEE Engineering in Medicine & Biology Society (EMBC) (pp. 1404-1407). IEEE.
[140] Cannestro, G. A., Abd, M. A., Engeberg, E. D. and Tognoli, E., 2020, October. Human Neuromarkers of Tactile Perception: State of the Art in Methods and Findings. In International Conference on Neurorehabilitation (pp. 635-639). Springer, Cham.
[141] Abd, M. A., Gonzalez, I. J., Colestock, T. C., Kent, B. A. and Engeberg, E. D., 2018, July. Direction of slip detection for adaptive grasp force control with a dexterous robotic hand. In 2018 IEEE/ASME International Conference on Advanced Intelligent Mechatronics (AIM) (pp. 21-27). IEEE.
[142] Abd, M. A., Bornstein, M., Tognoli, E. and Engeberg, E. D., 2018, July. Armband with soft robotic actuators and vibrotactile stimulators for bimodal haptic feedback from a dexterous artificial hand. In 2018 IEEE/ASME International Conference on Advanced Intelligent Mechatronics (AIM) (pp. 13-20). IEEE.
[143] Ingicco, J., AlSaidi, M., Abd, M., Ades, C. and Engeberg, E., 2018, May. Force and Pressure Control of Soft Robotic Actuators. In Proceedings. Florida Conference on Recent Advances in Robotics (Vol. 2018, p. 39). NIH Public Access.
[144] Abd, M. A., Gonzalez, I., Nojoumian, M. and Engeberg, E. D., 2017. Trust, satisfaction and frustration measurements during human-robot interaction. In Proceedings of the 30^{th} Florida Conference on Recent Advances in Robotics May 11-12 (Vol. 2107).
[145] Abd, M. A., Ades, C., Shuqir, M., Holdar, M., Al-Saidi, M., Lopez, N. and Engeberg, E. D., 2017. Impacts of soft robotic actuator geometry on end effector force and displacement. In 30^{th} Florida Conference on Recent Advances in Robotics, May (pp. 11-12).
[146] Abd, M., Gonzalez, I., Nojoumian, M. and Engeberg, E., 2017. Impacts of robot assistant performance on human trust, satisfaction, and frustration. RSS: Morality and Social Trust in Autonomous Robot

1. A neuro-interface platform comprising:
a neurophysiological unit comprising a multielectrode array (MEA) disposed in a chamber, the MEA comprising a first electrode at a recording region and a second electrode at a stimulation region, wherein the chamber is configured to house biological tissue comprising neurons, wherein the first electrode is configured to detect an efferent signal from the neurons at the recording region corresponding to neuronal activity, and wherein the second electrode is configured to provide electrical stimulation to the neurons at the stimulation region;
a sensorimotor unit comprising a test device, wherein the test device is configured to be selectively controlled based on a measurement of the efferent signal and to concurrently sense an afferent signal from a sensor coupled to the test device; and
an interface unit configured to electrically couple the neurophysiological unit and the sensorimotor unit.

2. The neuro-interface platform of claim 1, wherein the interface unit is configured to receive the afferent signal from the sensor of the test device and to transmit an electrical action potential to the neurons at the stimulation region according to a neurocomputational model.

3. The neuro-interface platform of claim 1, further comprising a processor; and a memory having instructions stored thereon, wherein the processor is configured to execute a trained AI model to classify the efferent signal and/or the afferent signal.

4. The neuro-interface platform of claim 3, wherein the processor is configured to evaluate a difference or change in the measurement of the efferent signal or the measurement of the afferent signal to a baseline measurement after a physical stimulus has been added to the chamber.

5. The neuro-interface platform of claim 3, wherein the processor is configured to evaluate a difference or change in the measurement of the efferent signal or the measurement of the afferent signal to a baseline measurement after a pharmacologic agent or chemical has been added to the chamber.

6. The neuro-interface platform of claim 3, wherein the trained AI model is retrained during operation.

7. The neuro-interface platform of claim 1, wherein the sensor comprises a tactile sensor.

8. The neuro-interface platform of claim 1, wherein the test device comprises a prosthetic device.

9. The neuro-interface platform of claim 1, wherein the first electrode and the second electrode are each a part of a first plurality of electrodes.

10. The neuro-interface platform of claim 1, wherein the neurophysiological unit comprises a plurality of MEAs.

11. The neuro-interface platform of claim 1, wherein the neurophysiological unit comprises an array of chambers arranged to provide high-throughput evaluation.

12. A method comprising:
providing a neuro-interface platform comprising a multielectrode array (MEA) disposed in a chamber with biological or synthetic tissue comprising neurons, and wherein the multielectrode array includes at least a first electrode and a second electrode;
detecting, using the first electrode disposed at a recording region of the neuro-interface platform, an efferent signal from the neurons at the recording region, wherein the efferent signal corresponds to neuronal activity;
selectively controlling a test device based on a measurement of the efferent signal while concurrently sensing an afferent signal from a sensor coupled to the test device; and
transmitting said afferent signal to the second electrode disposed at a stimulation region of the neurons, wherein the second electrode is configured to provide electrical stimulation to the neurons at the stimulation region.

13. The method of claim 12 further comprising:
generating, by a processor, a coherence image of the measurement of the efferent signal and/or afferent signal, wherein the coherence image is a time-frequency coherence image or comparison of spatiotemporal frequency decompositions from multiple electrode sites.

14. The method of claim 12, further comprising:
introducing a pharmacologic agent or chemical to the chamber with the biological or synthetic tissue; and
evaluating difference or change in the measurement of the efferent signal or the measurement of the afferent signal to a baseline measurement.

15. The method of claim 12, further comprising:
introducing physical stimulus to the chamber with the biological or synthetic tissue; and
evaluating difference or change in the measurement of the efferent signal or the measurement of the afferent signal to a baseline measurement.

16. The method of claim 12, wherein the neurons comprise a plurality of cultures of neurons.

17. The method of claim 12, wherein the neurons comprise cortical neurons.

18. The method of claim 12, wherein the recording region is positioned at a first region in the chamber and the stimulation region is positioned at a second region in the chamber spaced from the first region.

19. The method of claim 12, wherein the sensor comprises a tactile sensor.

20. The method of claim 12, wherein the test device comprises a prosthetic device.

21. (canceled)

22. (canceled)

23. (canceled)

24. (canceled)
